(19) United States
(12) Patent Application Publication
(10) Pub. No.: US 2024/0034030 A1
(43) Pub. Date: Feb. 1, 2024

(54) LAMINATED VEHICLE GLAZING AND DEVICE COMPRISING AN ASSOCIATED NEAR-INFRARED VISION SYSTEM

(71) Applicant: SAINT-GOBAIN GLASS FRANCE, COURBEVOIE (FR)

(72) Inventors: Keihann YAVARI, MARGNY-LES-COMPIEGNE (FR); Christophe KLEO, ATTICHY (FR); Thomas GALLINELLI, LE CREUSOT (FR)

(21) Appl. No.: 18/255,260

(22) PCT Filed: Nov. 30, 2021
(86) PCT No.: PCT/FR2021/052139

§ 371 Date: May 31, 2023

(30) Foreign Application Priority Data
Dec. 1, 2020 (FR) 2012487

(51) Int. Cl. B32B 17/10; B32B 3/26

(52) U.S. Cl. CPC B32B 17/10036; B32B 3/266; B32B 17/1022; B32B 17/10293; B32B 17/10385; B32B 17/10449; B32B 17/10633; B32B 2605/08; B32B 2307/204; B32B 2307/302; B32B 2307/412; B32B 2307/416

(57) ABSTRACT

A laminated glazing of a vehicle includes a first extra clear glass sheet (exterior glazing), a lamination interlayer and a second glass sheet (interior glazing) with two through-holes in this second sheet.

The invention relates to a laminated glazing, in particular a windscreen, in a vehicle particularly a road vehicle, of a train associated with a near infrared vision system. The invention likewise discloses a device combining said glazing and the vision system.

Autonomous vehicle glazings and the associated technology are constantly evolving, particularly for improving safety.

Laser remote sensing or LIDAR (an acronym for “light detection and ranging” or “laser detection and ranging”) can be used in the headlights of autonomous vehicles.

More recently, patent application WO20180153012 suggests placing a LIDAR operating in the near infrared between 750 nm and 1050 nm behind the laminated windscreen comprising two sheets of extra clear glass and an infrared filter.

The performance of this vision device (glazing associated with the LIDAR) can be improved.

More precisely, the present invention relates to a laminated (and/or curved) glazing of a vehicle, particularly of a road vehicle (car, truck, public transport: bus, coach, etc.) or railway vehicle (particularly with a maximum speed of at most 90 km/h or at most 70 km/h, in particular metros, trams), particularly curved, in particular a windscreen, or a rear window, perhaps a side glazing, of a given thickness E1, for example sub-centimetric, particularly of at most 5 mm for a road vehicle windscreen, glazing comprising:
a first glass sheet, particularly curved, intended to be the exterior glazing, with a first main external face F1 and a second main internal face F2 oriented toward the passenger compartment, if a motor vehicle with a thickness preferably of at most 4 mm, and even of at most 3 mm or 2.5 mm—particularly 2.1 mm, 1.9 mm, 1.8 mm, 1.6 mm and 1.4 mm—and preferably of at least 0.7 mm or 1 mm
a lamination interlayer (single or multi-laminations), optionally neutral, clear, extra clear or tinted particularly grey or green, made of polymer material preferably thermoplastic and better still polyvinyl butyral (PVB preferably including plasticizers), preferably if a road vehicle with a thickness of at most 1.8 mm, preferably of at most 1.2 mm and even of at most 0.9 mm (and preferably of at least 0.3 mm and even of at least 0.6 mm), the lamination interlayer being optionally acoustic and/or optionally having a cross section decreasing in the shape of a wedge from top to bottom of the laminated glazing (in particular a windscreen) for a head-up display (HUD), the lamination interlayer having a main face Fa oriented toward F2 and a main face Fb opposite Fa
a second glass sheet intended to be the interior glazing, preferably curved (like the first sheet) and in particular tinted, with a third main face F3 on the side of F2 and a fourth main internal face F4 oriented toward the passenger compartment, if a road vehicle with a thickness preferably less than that of the first glazing, even of at most 3 mm or 2 mm—particularly 1.9 mm, 1.8 mm, 1.6 mm and 1.4 mm—or even of at most 1.3 mm, and preferably of at least 0.7 mm, the thickness of the first and second glass sheets being preferably strictly less than 5 or 4 mm, even than 3.7 mm.

The second glass sheet particularly silica-based, soda lime-based, preferably soda-lime-silica-based, even aluminosilicate-based, or borosilicate-based has a total iron oxide content by weight (expressed in the form Fe₂O₃) of at least 0.4% and preferably of at most 1.5%.

The first glass sheet particularly silica-based, soda-lime-based, silica-soda-lime-based, or aluminosilicate-based, or borosilicate-based, has a total iron oxide content by weight (expressed in the form Fe₂O₃) of at most 0.05% (500 ppm), preferably of at most 0.03% (300 ppm) and of at most 0.015% (150 ppm) and particularly greater than or equal to 0.005%.

The glazing according to the invention additionally comprises:
a first through-hole in the thickness of the second glass sheet, the first through-hole being centimetric (in size) (according to the surface of the glazing)
a second through-hole, in the thickness of the second glass sheet, separated from the first through-hole, the second through-hole being centimetric (in size) (according to the surface of the glazing).

The second through-hole is under the first through-hole, separated by an interhole distance (Dt) of at least 8 cm, or 10 cm or even 15 cm and preferably of at most 50 cm or 30 cm.

The second glass sheet (with corners, square, rectangular, etc.) has an upper longitudinal edge face (in installed position).

In particular, the first through-hole opens onto said upper longitudinal edge face or is closed (surrounded by the wall of glass of the second sheet) the first through-hole is between the second hole and the upper longitudinal edge face (particularly interhole distance Dt is defined as the distance between the lowest point B1 of the wall delimiting the first through-hole and the highest point A2 of the wall delimiting the second through-hole, in installed position).

Thus according to the invention, the following is selected in order to reach a high level of transmission:
1) an exterior glass that is extra clear in the near-infrared region,
2) an interior glass that is more absorbent in the near-infrared region and necessarily hollowed out.

This solution is more efficient than the one that is based on two solid extra clear glass sheets.

Additionally, by avoiding the use of a second extra clear glass sheet, it improves the comfort (heat inside the vehicle), aesthetics and is less expensive.

Iron oxide, present as an impurity in most of the natural raw materials used in glassmaking (sand, feldspar, limestone, dolomite, etc.), absorbs both in the visible and near-ultraviolet region (absorption due to the ferric ion Fe³⁺) and especially in the visible and near-infrared region (absorption due to the ferrous ion Fe²⁺). This is why the iron oxide is reduced in the first glass sheet.

In the second glass sheet, the choice can be made to have a higher level of iron oxide.

The invention is particularly suitable for glazings (windscreen, window, etc.) for autonomous or semi-autonomous vehicles: levels L2+, L3, L4 and L5 (“full” automation) as well as vehicles such as Robot Taxis and shuttles, etc.

The angle of the glazing particularly a windscreen of a road vehicle can typically be between 21° and 36° with respect to the ground and on average 300.

According to the invention, two through-holes are made which makes it possible to separate the emitting part and the receiving part of the infrared vision system and to avoid the overlap of the beams which reduces the vertical field of view.

This also allows for greater freedom of design and particularly it is possible to choose a second hole that is narrower than the first through-hole.

It is easier to produce two holes and this makes it possible to maintain better mechanical strength of the glazing than a single large hole.

The minimum interhole distance Dt is selected in order to avoid having a fragility zone between the two through-holes.

The maximum interhole distance Dt is selected in order to confine the lidar system to a restricted area of the glazing, namely preferably the upper and even central part of the glazing (particularly windscreen).

The glazing thus comprises a first communication window encompassing a first zone of the first glass sheet facing said first through-hole.

The glazing thus comprises a second communication window encompassing a second zone of the first glass sheet facing said second through-hole. Better still, if the emitter of the infrared vision system is positioned facing the second through-hole and the receiver of the infrared vision system is positioned facing the first through-hole, the propagation of stray radiation propagating by total reflection in the external glass and/or reflecting on face F2 is reduced. Two vertical holes are selected instead of two horizontal holes (which allows for greater discretion) also to avoid stray radiation.

In one embodiment:
the first through-hole is larger than the second through-hole, for example the first through-hole has a first surface cross section S1 particularly trapezoidal or rectangular or oval-shaped or disc-shaped, with a largest dimension (particularly horizontal) of at most 30 cm or 25 cm or 20 cm, preferably with a smallest dimension (particularly horizontal) of at least 3 cm or 5 cm
and preferably the second through-hole has a second surface cross section S2 less than S1, particularly trapezoidal or rectangular or oval-shaped or disc-shaped, in particular of the same shape as S1, with a largest dimension of at most 30 cm or 25 cm or 20 cm or 15 cm and preferably with a smallest dimension of at least 2, 3 or 5 cm.

In particular the second through-hole has a horizontal dimension L2, referred to as length, which is less than the horizontal dimension L1, referred to as length, of the first through-hole.

The first through-hole and the second through-hole are preferably in a peripheral region, preferably the upper part of the glazing (in installed position), and even in a peripheral central region. The first and second through-holes are in particular located in one region and take up less than 10% or even less than 1% of the glazing. For example the lower edge of the second through-hole is at most separated by 50 cm from the upper longitudinal edge face of the glazing.

The first through-hole can be:
closed hole (surrounded by the wall of the second glass sheet), therefore within the glazing particularly spaced apart from the closest edge face of the glazing by at least 3 cm or 5 cm
open or opening, forming a notch (peripheral).

And the second through-hole is preferably closed.

The shape and dimensions of the first and second through-holes are configured according to the techniques of the art in order to effectively and selectively collect all the radiation passing through the glazing (windscreen, window, etc.), particularly in the case of LIDAR those reflected from a solid angle range outside the vehicle and coming from the area in front of the vehicle that is to be captured via the LIDAR.

If the first through-hole is a notch a part of this notch will be masked by the frame of the glazing and thus non-functional for the vision system. If the first hole is closed it is too close to the edge and the same occurs.

If the first through-hole is closed, the edge of the first through-hole closest to the edge face of the glazing (preferably upper longitudinal edge and particularly in a central zone) is spaced apart from this edge face of the glazing (of the second sheet) preferably by at least 2 cm or 3 cm and preferably 5 cm.

The first through-hole can be in the central zone of the upper longitudinal edge of the windscreen, the usual zone of the interior rearview mirror (rearview mirror adjacent to the first through-hole or rearview mirror eliminated depending on the vehicle), zone where a masking layer on face F2 and/or bonded to the interlayer is generally wider than on the adjacent lateral zones along the longitudinal upper edge (passenger, driver, etc.).

The first through-hole and even the second through-hole is preferably longer than it is high.

Preferably, the first through-hole has a horizontal dimension, referred to as length L1, (parallel to the upper longitudinal edge) and a vertical dimension of the first hole, referred to as height H1 (perpendicular to the upper longitudinal edge), the length L1 is greater than the height H1 and likewise the second through-hole has a horizontal dimension, referred to as length L2, (parallel to the upper longitudinal edge) and a vertical dimension, referred to as height H2 (perpendicular to the upper longitudinal edge), the length L2 is greater than the height H2.

And the horizontal dimension L2 of the second through-hole is less than the horizontal dimension L1 of the first hole. H1 and H2 can be identical or similar.

Preferably, the first through-hole has a section, particularly trapezoidal or oval-shaped or disc-shaped—with smallest dimension of at least 3 cm (adapted to the size of the infrared vision system for example)—and preferably with largest dimension (in particular large side or diameter according to the horizontal L1) of at most 30 cm, 25 cm, 20 cm (for mechanical aspects).

Preferably, the second hole has a section, particularly trapezoidal or oval-shaped or disc-shaped,—with smallest dimension of at least 2 cm (adapted to the size of the infrared vision system for example)—and preferably with largest dimension (in particular large side or diameter according to the horizontal L2) of at most 40 cm, 30 cm, 25 cm, 20 cm or 15 cm (for mechanical aspects).

In particular, the cross section of the first hole is a quadrilateral, particularly a rectangle or trapezoid, with:
a first so-called upper (large) longitudinal side (closest to the edge face of the upper longitudinal edge of the glazing) preferably parallel to the edge face of the upper longitudinal edge of the glazing and of a length L1a preferably of at most 30 cm, 20 cm or 15 cm or 12 cm and particularly spaced apart by at least 5 cm or 6 cm from the edge face (of the upper longitudinal edge of the glazing)
a second so-called lower (large) longitudinal side (farthest from the edge face of the upper longitudinal edge of the glazing, closer to the central zone) preferably parallel to the edge face of the upper longitudinal edge of the glazing and of a length L1b preferably of at most 35 cm or 30 cm or 25 cm or 20 cm and preferably greater than that of the first large side
of a height (between these first and second large sides) preferably of at least 5 cm and even of at most 15 cm.

In particular the cross section of the second hole is a quadrilateral, particularly a rectangle or trapezoid, preferably of the same shape as the first hole with:
a first so-called upper (large) longitudinal side (closest to the edge face of the upper longitudinal edge of the glazing) preferably parallel to the edge face of the upper longitudinal edge of the glazing and of a length L2a preferably of at most 20 cm or 15 cm or 12 cm and particularly spaced apart by at least 5 cm or 6 cm from the edge face (of the upper longitudinal edge of the glazing)
a second so-called lower (large) longitudinal side (farthest from the edge face of the upper longitudinal edge of the glazing, closer to the central zone) preferably parallel to the edge face of the upper longitudinal edge of the glazing and of a length L2b preferably of at most 25 cm or 20 cm and preferably greater than that of the first large side L2b
of a height (between these first and second large sides) preferably of at least 5 cm and even of at most 20 cm or 15 cm.

The second large side of the first through-hole is shorter than the first large side of the second through-hole for example L2a, the height H2 of the second through-hole can be identical or similar to the height H1 of the first through-hole.

A central line M is defined passing through the middle of the upper edge which can be an axis of symmetry of the glazing. The first and second through-holes may be central and then the line M passes by these two through-holes and divides each through-hole into two particularly identical parts.

In one embodiment, the glazing comprises a heating zone (by wire(s), by layer) which takes up all or part of the surface of the glazing, conventionally made of a material that is transparent in the visible region but not necessarily transparent enough at the infrared working wavelength of the infrared vision system (LIDAR) in a range from 800 nm to 1800 nm, in particular between 850 nm and 1600 nm. In particular there can be a first so-called main heating zone, extending over all or part of the glazing optionally outside the zone in front of the first through-hole and in front of the second through-hole.

In one embodiment, the glazing according to the invention can comprise at least one metal wire (a coiled wire, for example) particularly heating bonded to the lamination interlayer, within the lamination or particularly on the side of face Fb particularly anchored on face Fb (or even on the side of Fa, anchored on Fa) and optionally absent in front of said first through-hole and said second through-hole.

It may be sought to avoid the heating wire or wires facing the first and second through-holes for reasons of optical distortions.

It may also be desirable for the two communication windows to be protected against frost and mist particularly by heating.

This can be done by one or more heating metal wires located facing the first and second through-holes or in the vicinity thereof or even by one or more heating wires extending over all or part of the glazing. The arrangement of the one or more wires can make it possible to maintain overall transparency at the infrared working wavelength.

This can also be done by a local heating layer facing the first and second through-holes or even a common heating layer covering the two communication windows, made of a material that is transparent at the infrared working wavelength.

More precisely, it is possible to have:
a first local heating zone in front of said first through-hole, particularly by an arrangement of tracks or wire(s) (wire(s) etc.) made of a material that is absorbent—to maintain overall transparency—at the infrared working wavelength in a range from 800 nm to 1800 nm, in particular between 850 nm and 1600 nm, or of a material that is transparent at the infrared working wavelength
a second local heating zone in front of said second through-hole, particularly by an arrangement of tracks or wire(s) (wire(s) etc.) made of a material that is absorbent—to maintain overall transparency—at the infrared working wavelength in a range from 800 nm to 1800 nm, in particular between 850 nm and 1600 nm, or of a material that is transparent at the infrared working wavelength.

The first local heating zone can extend beyond the first through-hole for example over at most 30 mm. It can have the same shape as the first through-hole, particularly homothetic (trapezoidal etc.) or even any other shape for example rectangular (and trapezoidal hole).

In the same way, the second local heating zone can extend beyond the second through-hole for example over at most 30 mm. It can have the same shape as the through-hole, particularly homothetic or even any other shape for example rectangular.

A heating zone can be connected to at least two electrical leads which are in particular flat connectors or (in the case of a heating layer) electroconductive busbars intended for connecting to a voltage source so that a current path for a heating current is formed therebetween. It is not always necessary to have busbars in the case of heating wire(s) for which a flat connector (useful for point contacts such as wires) can be used for each local heating zone or for a common heating zone that encompasses both zones.

These first and second local heating zones can be separated with discrete busbars or with at least one busbar in common for example there can be a common heating zone with common busbars.

A heating material can be provided (opaque discontinuous or transparent in layer), that simultaneously covers the first and second through-holes.

Thus at least two busbars are used, preferably entirely or partially offset from the first and second through-holes, particularly:
first and second busbars common to the first and second local heating zones (on either side of the first and second through-holes)
first, second bus bus (on either side of the first and second through-holes) and a third common busbar between the first and second through-holes for the two local heating zones
or first and second busbars for the first local heating zone, third and fourth busbars for the second local heating zone.

It is possible in particular to have:
an optional main heating zone with at least two electrical leads typically in the peripheral zone of the glazing (on the same edge, on two opposite edges or even two adjacent edges of the glazing), for example by an electroconductive heating coating (holes in line with the first and through-holes)
the first local heating zone with at least two local busbars or electrical leads, first and second busbars in the vicinity of the first through-hole and preferably offset from the zone of said first through-hole (or protruding over at most 10 mm or 5 mm or 3 mm in the second hole), first and second local busbars on the same side or on two sides (opposite or adjacent) of the first through-hole
the second local heating zone in front of said second through-hole, particularly with at least two local busbars or electrical leads, third and fourth busbars in the vicinity of the second through-hole and preferably offset from the zone of said second through-hole (or protruding over at most 10 mm or 5 mm or 3 mm into the second hole), third and fourth local busbars on the same side or on two sides (opposite or adjacent) of the second through-hole.

One or the busbars (local) can be continuous or discontinuous by sections.

It is also possible to have a common local heating zone for the first and 10 second through-holes, with two common local busbars on either side of the first and second through-holes.

According to one configuration the glazing comprises the heating layer (electroconductive coating) made of a material transparent at least at one so-called infrared working wavelength in a range from 800 nm to 1800 nm, in particular between 850 nm and 1600 nm, encompassing a surface facing the first and second holes in order to form the first and second local heating zones separated by a discontinuity made by laser etc.) of the heating layer, for example of sub-centimetric width, in the zone between the first and second through-holes.

For example the discontinuity is horizontal, the first, second, third fourth busbars can be vertical or horizontal.

Preferably with the heating layer (electroconductive coating) made of transparent material, the busbars (for each heating zone or for the common heating zone) are separated by at most 40 cm, 30 cm or 20 cm and/or are lateral (oblique or vertical).

The local busbars (two pairs of busbars, three busbars, or two common busbars) are preferably masked from the outside by an opaque coating masking element and/or opaque film in contact with, on face F2 or on or inside the lamination interlayer.

The busbars (local) are in the form of particularly rectangular strips which are (at least in part) outside the zone of the first through-hole and of the second through-hole.

The width of the busbars (local) is preferably from 2 mm to 30 mm, in a particularly preferred way from 4 mm to 20 mm and in particular from 10 mm 10 to 20 mm.

A busbar (local) particularly in a layer (printed) preferably contains at least one metal, a metal alloy, a metal and/or carbon compound, in particular preferably a noble metal and, in particular, silver. For example, the printing paste preferably contains metal particles, metal and/or carbon particles and, in particular, noble metal particles such as silver particles. The thickness of a layer busbar (printed) can preferably be from 5 μm to 40 μm, in a particularly preferred way from 8 μm to 20 μm and more particularly preferably from 8 μm to 12 μm.

Alternatively, however, it is possible to use for one or each busbar (local) an electroconductive sheet, particularly a strip, for example rectangular. The busbar then contains, for example, at least aluminum, copper, tinned copper, gold, silver, zinc, tungsten and/or tin or alloys thereof. This sheet busbar (strip) preferably has a thickness of 10 μm to 500 μm, in a particularly preferred way of 30 μm to 300 μm.

The sheet busbar is in particular used for the heating wires bonded to the lamination interlayer.

The first and second busbars are preferably at a distance of at most 1 cm from the first through-hole. The third and fourth busbars are preferably at a distance of at most 1 cm from the second through-hole.

In the case of common local busbars, the first common busbar is preferably at a distance of at most 1 cm from the first through-hole, the second common busbar is at a distance of at most 1 cm from the second through-hole.

The first busbar is preferably (substantially) horizontal and closest to the upper longitudinal edge of the glazing and the second busbar is then preferably (substantially) horizontal, first and second busbar on either side of the first through-hole. And the third busbar is preferably (substantially) horizontal and closest to the first through-hole and the fourth busbar is then preferably (substantially) horizontal, third and fourth busbar on either side of the second through-hole.

The supply of power is for example of 15 V or 48 V.

The length of the busbars for example equal to or longer than the sides of the through-holes facing them can be adapted to measure.

Preferably the busbars are on both sides of each of the first and second through-hole or of two of the first and second through-hole.

It is sought to bring the busbars (associated with a heating zone) as close together as possible to increase the power density in the transparent heating layer. Preferably the distance between busbars (of each heating zone) is at most 30 mm or 20 mm.

The supply of power of the (first, second, third, fourth) busbars can be provided wirelessly and/or with a connector (wires, flat connectors, etc.). In order for the optional connections to be more easily outside of the frame of the first through-hole (of the first communication window) the third and fourth horizontal busbars can be longer than the second through-hole and longer than the first through-hole (than the first and second horizontal busbars).

The busbars can be lateral, that is to say to the left and right of the through-holes along the lateral edges of the glazing.

The first busbar can be preferably lateral (vertical or oblique) and the second busbar is then preferably (substantially) lateral (vertical or oblique), first and second busbar on either side of the first through-hole. And the third busbar is preferably lateral (vertical or oblique) and the fourth busbar is then preferably lateral (vertical or oblique), third and fourth busbar on either side of the second through-hole.

The first, second, third, fourth lateral busbars can be aligned.

In a first configuration (with horizontal dedicated busbars):
the first local busbar (sheet or coating) is adjacent and even parallel to a first large side of the first trapezoidal (or rectangular) through-hole preferably large side closest to the upper longitudinal edge of the glazing,
the second local busbar (sheet or coating) is adjacent and even parallel to a second large side of the first trapezoidal (or rectangular) through-hole, busbars on either side of the first through-hole.

And even:
the third local busbar (sheet or coating) is adjacent and even parallel to a second large side of the second trapezoidal (or rectangular) through-hole, preferably large side closest to the first through-hole
the fourth local busbar (sheet or coating) is adjacent and even parallel to a second large side of the second trapezoidal (or rectangular) through-hole, busbars on either side of the second through-hole.

In a second configuration (with lateral dedicated busbars (vertical or oblique)):
the first local busbar (sheet or coating) is adjacent and even parallel to a first small side of the first trapezoidal (or rectangular) through-hole
the second local busbar (sheet or coating) is adjacent and even parallel to a second first small side of the first trapezoidal (or rectangular) through-hole, busbars on either side of the first through-hole.

And even:
the third local busbar (sheet or coating) is adjacent and even parallel to a second small side of the second trapezoidal (or rectangular) through-hole
the fourth local busbar (sheet or coating) is adjacent and even parallel to a second small side of the second trapezoidal (or rectangular) through-hole, busbars on either side of the second through-hole.

These third and fourth busbars can be aligned with the first and second busbars or offset from the first and second busbars.

In a third configuration (with dedicated horizontal busbars adjacent two by two):
the first local busbar adjacent and even parallel to a first large side of the first trapezoidal (or rectangular) through-hole, preferably large side closest to the first through-hole
the second local busbar adjacent to the first local busbar along said first large side (closest to the upper longitudinal edge) preferably large side closest to the first through-hole

And even:
the third local busbar adjacent and even parallel to a first large side of the second trapezoidal (or rectangular) through-hole
the fourth local busbar adjacent to the first local busbar along said second large side of the second trapezoidal through-hole

In a fourth configuration only three busbars (a common horizontal busbar) are used for the two local heating zones:
the first local busbar adjacent and even parallel to a first large side of the first trapezoidal (or rectangular) through-hole, particularly large side closest to the upper longitudinal edge,
   the second local busbar adjacent and even parallel to a first large side of the second trapezoidal (or rectangular) through-hole,
   the third local busbar adjacent and even parallel to a first large side of the second trapezoidal (or rectangular) through-hole
   the fourth local busbar adjacent to the first local busbar along said second large side of the second trapezoidal through-hole.

In a fourth configuration only two busbars (common, horizontal) are used for the two local heating zones:
the first local busbar adjacent and even parallel to a first large side of the first trapezoidal (or rectangular) through-hole, particularly large side closest to the upper longitudinal edge,
   the second local busbar adjacent and even parallel to a first large side of the second trapezoidal (or rectangular) through-hole, particularly large side closest to the upper longitudinal edge.

In a fifth configuration only two lateral busbars (common) (vertical or oblique) are used for the two local heating zones:
the first local busbar adjacent and even parallel to a first small side of the first trapezoidal (or rectangular) through-hole,
   the second local busbar adjacent and even parallel to a first large side of the second trapezoidal (or rectangular) through-hole,

In the case of round or oval-shaped through-holes the busbars (substantially horizontal or lateral, common or dedicated busbars) can be curved to match the shape of the through-holes.

Vertical or oblique lateral bus bars (parallel with respect to the small sides of the through-holes) may be preferred since the horizontal bus bars can result in local overthicknesses that lead to distortions.

To facilitate the connections, in a sixth embodiment, one or more flat connectors or all the busbars of the first and second local heating zones—common or dedicated busbars, in particular first, second, third busbar, fourth busbar—are grouped together in a zone peripheral to the first through-hole, particularly which is located between the upper longitudinal edge and the first through-hole and/or adjacent to a lateral edge of the first through-hole.

The first or second local heating zone and/or overall heating zone comprises for example one or a plurality of individual metal wires, referred to as “heating metal wires” which connect the “busbars” to one another. The heating current passes through these individual metal wires.

In particular, the glazing can comprise at least one first metal wire (a coiled wire for example) particularly heating bonded to the lamination interlayer facing the first through-hole particularly:
on the side of face Fb particularly anchored on face Fb or
within the lamination interlayer between a first lamination (on the side of face F2) and second interlayer (on the side of face F3), laminations of identical or different thicknesses, etc.
or even particularly on the side of face Fa particularly anchored on face Fa.

And even:
at least one particularly heating metal wire discrete from or corresponding to said first metal wire, facing the second through-hole bonded to the lamination interlayer
   on the side of face Fb particularly anchored on face Fb or
   within the lamination interlayer between a first lamination (on the side of face F2) and second interlayer (on the side of face F3), laminations of identical or different thicknesses, etc.
   or even particularly on the side of face Fa particularly anchored on face Fa.

And optionally the first wire (or the first wires) is facing the first through-hole, particularly between the first and second through-holes and facing the second through-hole.

It is possible to use two common busbars only as already explained previously.

It is also thus possible to use one or more metal wires in common for the two holes.

The heating wire or wires particularly have a thickness less than or equal to 0.1 mm preferably made of copper, tungsten, gold, silver or aluminum or alloys of at least two of these metals.

The wire or wires are advantageously very thin so as not to impair, or only very slightly impair, the transparency of the glazing. Preferably, the metal wires have a thickness less than or equal to 0.1 mm, in particular between 0.02 and 0.04 mm and ideally between 0.024 mm and 0.029 mm. The metal wire or wires preferably contain copper, tungsten, gold, silver or aluminum or an alloy of at least two of these metals. The alloy can also contain molybdenum, rhenium, osmium, iridium, palladium or platinum.

The metal wire or wires are preferably electrically insulated.

In one embodiment, the glazing according to the invention comprises a functional element:
on one of faces Fa or Fb of the lamination interlayer (single or multi-laminations)
or within said lamination interlayer, between a first lamination and a second interlayer,
functional element (flexible, curved)—of sub-millimetric thickness—comprising a (flexible) sheet of sub-millimetric thickness particularly of at most 200 μm or 100 μm, particularly polymer, for example conductive polymer, and optionally on a first main face oriented toward face F2 or F3 a particularly electroconductive coating or an element that is opaque in the visible region (film or coating), functional element:
with a first zone facing the first through-hole preferably with the electroconductive coating
with a second zone facing the second through-hole preferably with the electroconductive coating.

Said functional element particularly a heating element is transparent at the infrared working wavelength in a range from 800 nm to 1800 nm, in particular between 850 nm and 1600 nm at least in the first and second zones facing the first through-hole and the second through-hole.

Said functional element is preferably present between the first and second through-hole, thus taking up a surface encompassing the first and second through-holes, the optional (electroconductive) coating is optionally absent or protruding by at most 1 cm, 5 mm or 3 mm (from the walls) of the first and second through-holes.

It is possible to contemplate a functional element that is opaque at the working length (film and/or coating on top) outside the zones of the through-holes.

Outside the zones of the through-holes, this functional element (heating) is for example opaque or made opaque in the visible region. For example it extends a peripheral masking layer (enamel for example) particularly on face F2 or on the interlayer (ink) which is a strip in order to create (viewed from the outside a widened opaque zone particularly in the central zone. Preferably the opaque element or the element made opaque has substantially the same color (black etc.) and/or optical density as the peripheral masking layer (black etc.). For example the optical density difference between opaque element and opaque masking layer is at most 5%, 3%, 2% and they are even the same color.

This functional element can be local, in the region of the through-holes (taking up a fraction of the glazing surface).

The functional element can be local, in the region of the first and second through-holes and take up less than 30, 10%, 5% of the glazing.

The functional element can have any general rectangular or square shape, identical and even homothetic to the shape of the first (or second) through-hole.

The functional element if necessary can be bi-material in line with the first and second through-holes in order to be transparent at the working wavelength.

The distance between the upper longitudinal edge and the functional element can be of at most 30 mm, 20 mm 15 and even 10 mm.

In particular:
the functional element (the sheet) comprises on the first main face oriented toward face F2 or F3 a heating electroconductive coating facing the first through-hole and facing the second through-hole, forming first and second local heating zones (separated or not, as already disclosed previously)
and/or the functional element (the sheet) comprises on the first main face or the second main face an opaque masking element (bonded opaque film or coating) at least partially offset (absent from the center) from the first through-hole and at least partially offset (absent from the center) from the second through-hole.

The opaque zone can take up substantially the entire surface of the functional element, or at least 80% or 90% and with two openings in line with the first and second through-holes. The dimensions of the two openings can be smaller, equal or greater than those of the first and second through-holes.

The opaque masking element (bonded opaque film or coating) can protrude into the first through-hole particularly by at most 50 mm, 20 mm, 10 mm and even by at least 5 mm, 7 mm, 2 mm.

If the second through-hole is smaller than the first through-hole then the second zone with the opaque coating can likewise be smaller than the first zone with the coating.

The opaque masking element (bonded opaque film or coating) can protrude into the second through-hole particularly by at most 50 mm, 20 mm, 10 mm and even by at least 5 mm, 7 mm, 2 mm.

The busbars (horizontal or lateral, etc.) are on the sheet optionally under or above the masking element (on the same first face, for example oriented toward face Fb) or spaced apart from the masking element (on the same first face, for example oriented toward face Fb or on the second main face).

The functional element can have an overall surface (rectangular, trapezoidal, etc.) encompassing the first and second zones.

In particular the film forms a rectangular overall surface encompassing the holes for example each of trapezoidal section.

For example the film comprises an electroconductive coating present at least facing the through-holes for example with a shape homothetic to the holes (trapezoidal) or encompassing the holes (rectangle and trapezoidal holes). For example the electroconductive coating comprises two separate zones (rectangular or trapezoidal or oval-shaped, etc.).

The electroconductive coating (heating or not) can also take up substantially the entire surface of the film or at least 70%, 80%. The optional busbars connected to the conductive coating are outside the first and second zones but in the vicinity preferably for example at less than 1 cm.

The coating can be oriented toward face F2 or on the side of the through-hole. Its thickness can be sub-micronic. This is single or multi-layered, particularly mineral.

The element can have a shape (trapezoidal, rectangular etc. with rounded corners.

The sheet of polymer material of the functional element can be a plastic film particularly with a thickness of 10 to 100 μm. The plastic film can more broadly be made of polyamide, polyester, polyolefin (PE: polyethylene, PP: polypropylene), polystyrene, polyvinyl chloride (PVC), polyethylene terephthalate (PET), polymethyl methacrylate (PMMA) or polycarbonate (PC). A clear film is preferred, in particular PET.

Use may be made, for example, of a coated clear PET film, for example XIR from the company Eastman, a coextruded film made of PET-PMMA, for example like SRF 3M®, but also numerous other films (for example made of PC, PE, PEN, PMMA, PVC).

The functional element (the sheet) can comprise on the first main face (on the side of the electroconductive coating or on the opposite side) or a face opposite one or more other elements in particular moisture sensors, rain sensor, light sensor (photodiode), sensor forming an antenna, for receiving and/or transmitting electromagnetic waves (radio, TV, particularly a local communication network such as BLUETOOTH, WIFI, WLAN), an acoustic sensor (based on a piezoelectric element), an ultrasound signal detector, a diagnostic sensor, a command detector (windscreen wiper etc.), for example IR command or voice command (piezoelectric), an electroluminescent screen (organic or inorganic), a liquid crystal screen or any other electrically controllable device, etc.

The number of openings of the opaque functional element is adapted according to the number of sensors and camera, screen(s), device requiring it.

Furthermore, cumulatively or alternatively to the functional element bonded to the interlayer, the glazing can comprise on face F2, a functional element of sub-millimetric thickness, particularly of at most 200 μm or 100 μm, particularly a functional coating or a functional film adhered to face F2 (by pressure-sensitive adhesive for example), functional element:
with a first zone facing the first through-hole
with a second zone facing the second through-hole, preferably extending under the lamination interlayer between the first and second zones,
functional element transparent at least at one so-called infrared working wavelength in a range from 800 nm to 1800 nm, in particular between 850 nm and 1600 nm at least in the first and second zones.

The functional element on face F2 can be local, in the region of the first and second through-holes and take up less than 30, 10%, 5% of the glazing.

The functional element on face F2 can have any rectangular or square general shape, identical and even homothetic to the shape of the first (or second) through-hole. The functional element on face F2 can be a coating which:
is spaced apart from an adjacent layer on face F2, in particular opaque masking layer (black, enamel) with resists in line with the first and second through-holes, therefore
either covers or is under, over less than 5 cm, or 1 cm, an adjacent layer on face F2 in particular an opaque masking layer (particularly black, enamel or others) with resists in line with the first and second through-holes.

It is sought to increase LIDAR reliability, also preferably the glazing according to the invention preferably has an anti-reflective coating at least at one so-called infrared working wavelength in a range from 800 nm to 1800 nm, in particular between 850 nm and 1600 nm, anti-reflective coating particularly based on (nano)porous silica:
with a first free anti-reflective surface in the zone of the first through-hole
with a second free anti-reflective surface in the zone of the second through-hole.

Optionally the anti-reflective coating extends under the lamination interlayer between the first and second free anti-reflective surfaces thus forming a single surface, the anti-reflective coating on face F2 being particularly under an optional a functional layer, or is on an optional a functional layer which is on face F2, in particular masking layer.

The first free surface of the anti-reflective coating can be under the first hole (on face F2, on a support on the side of face Fb), in the first hole or even projecting from the first hole on the side of the passenger compartment on a first part optionally present in the first hole. The second free surface of the anti-reflective coating can be under the first hole (on face F2, on a support on the side of face Fb), in the second hole or even projecting from the second hole on the side of the passenger compartment on a second piece optionally present in the second hole.

The anti-reflective coating, particularly based on (nano)porous silica, can be in particular on face F2, the lamination interlayer then has a first interlayer through-hole facing the first through-hole, and a second interlayer through-hole facing the second through-hole.

The anti-reflective coating is preferably local.

The particularly local anti-reflective coating can preferably protrude by at most 100 mm, 50 mm, 30 mm or 20 mm or 10 mm between face F2 and face Fa (in the vicinity of each of the first and second through-holes).

Between face F2 and face Fa, the anti-reflective coating can be on or under a functional layer that is on face F2 particularly an opaque masking layer or a heating layer or a sunlight control layer.

Face F2 then comprises a common anti-reflective coating with a free surface in all the first and second through-holes or a discrete local anti-reflective (AR) coating for each first and second through-hole, and for example the local AR coatings have different thicknesses.

The first and second through-holes are preferably in a peripheral zone of the laminated glazing preferably on the upper longitudinal edge and better still in a peripheral central region and the anti-reflective coating is local and in this peripheral region.

The first and second through-holes each have a given shape, particularly with a convex straight cross section, for example trapezoidal or rectangular or square or ellipsoidal or oval-shaped or round. The anti-reflective coating can have a homothetic shape.

The anti-reflective coating can have the same shape as the section of the first hole and of the second hole for example trapezoidal or even rectangular, etc.

The anti-reflective coating can be only facing the first and second through-holes or cover a surface that encompasses them.

Although less preferred on the face of it, the anti-reflective coating can be only in a central zone facing said first through-hole, it does not protrude from the first through-hole and even is spaced apart from the edge of the first through-hole preferably by at most 1 cm. For example the free surface in the first through-hole has a length and/or a side of at least 5 cm, 10 cm, 15 cm and preferably of at most 30 cm. And, the anti-reflective coating can be only in a central zone facing said second through-hole, it does not protrude from the second through-hole and even is spaced apart from the edge of the second through-hole preferably by at most 1 cm. For example the free surface in the second through-hole has a length and/or a side of at least 5 cm, 10 cm, 15 cm and preferably of at most 30 cm.

The assembly of the first glass sheet with said anti-reflective coating has:
a total transmission of at least 90.0%, 91.0%, or even 92.0% or 93% at the working wavelength particularly 905±5 nm and/or 1550±5 nm measured at the normal (90°) or even preferably also at 60° or even up to 60° with respect to the plane (local) of the first sheet for example on the side of face F2 and/or on the side of face F1
and/or the anti-reflective coating increases by at least 1%, 2% or 2.5% or even 3.0% at the working wavelength the total transmission of the first glass sheet measured at the normal (90°) or even preferably also at 60° and even up to 60° with respect to the plane (local) of the first sheet for example on the side of face F2 and/or on the side of face F1.

The infrared transmission is measured for example with a Fourier spectrometer such as BrukerVertex-70.

Obviously if a multi-spectrum vision system is used, it may also be desirable for the assembly of the first glass sheet with said anti-reflective coating to have:
a total transmission of at least 90%, 91%, or even 92% at another working wavelength in the visible region particularly between 500 nm and 600 nm measured at the normal and even preferably from 90° to 60° with respect to the plane of the first sheet, for example on the side of face F2 and/or on the side of face F1
and/or the anti-reflective coating increases by at least 1%, 2% or 2.5% or even 3% at the second working wavelength the total transmission of the first glass sheet measured at the normal or even preferably from 90° to 60° with respect to the plane of the first sheet for example on the side of face F2 and/or on the side of face F1.

The anti-reflective coating can comprise a stack of thin dielectric layers (of oxide and/or of metal or silicon nitrides, for example) alternating high and low refractive indexes (at the working wavelength).

The anti-reflective coating preferably comprises a (functional) layer of porous silica, particularly nanoporous, preferably sol-gel.

In a first embodiment, the pores are the gaps of a non-compact stack of nanometric beads, particularly of silica, this layer being disclosed for example in document US20040258929.

In a second embodiment, the porous layer is obtained by depositing a condensed silica sol (silica oligomers) densified by vapors like NH3, this layer being disclosed for example in document WO2005049757.

In a third embodiment, the porous layer can also be of the sol-gel type as is disclosed in document EP1329433. The porous layer can also be obtained with other known pore-forming agents: micelles of cationic surfactant molecules in solution and, optionally, in hydrolyzed form, or of anionic, non-ionic surfactants, or amphiphilic molecules, for example block copolymers.

In a fourth embodiment, the porous layer can also be of the sol-gel type as is disclosed in document WO2008/059170. The porous layer can thus be obtained with pore-forming agents which are preferably polymeric beads.

The anti-reflective coating particularly of porous silica according to the invention can have a thickness advantageously comprised between 10 nm and 10 μm (including these limit values), in particular 50 nm and 1 μm and even more preferentially between 70 and 500 nm.

The layer of porous (or nanoporous) silica can have closed pores of at least 20 nm, 50 nm or 80 nm optionally the functional layer can comprise pores with a concentration increasing in the direction of the free surface.

The pores can have an elongated shape, particularly like a grain of rice. Even more preferentially, the pores can be substantially spherical or oval-shaped. It is preferred for the majority of the closed pores, or at least 80% of them, to have a substantially identical shape, particularly elongated, substantially spherical or oval-shaped.

The porous silica can be doped for example to further improve its hydrolytic content in the case of applications which require great strength (façades, exteriors, etc.). The doping elements can preferably be selected from Al, Zr, B, Sn, Zn. The dopant is introduced to replace the Si atoms in a molar percentage that can preferably reach 10%, even more preferentially up to 5%.

The anti-reflective coating can comprise a chemical protection underlayer particularly with a thickness of at most 200 nm for example, particularly a dense silica layer, by sol-gel with a sol-gel functional layer of porous silica on top.

The underlayer can be based on silica or at least partially oxidized derivatives of silicon selected from silicon dioxide, sub-stoichiometric silicon oxides, oxycarbide, oxynitride or oxycarbonitride of silicon.

The underlayer is useful when the underlying surface is made of soda-lime-silica glass because it acts as a barrier to the alkalis.

This underlayer therefore advantageously comprises Si, O, optionally carbon and nitrogen. But it can also include minority materials with respect to the silicon, for example metals like Al, Zn or Zr. The underlayer can be deposited by sol-gel or by pyrolysis, particularly by gas-phase pyrolysis (CVD). The latter technique makes it possible to obtain layers of SiOₓC_{y} or SiO₂ quite easily, particularly by deposit directly on the float glass ribbon in the case of glass substrates. But the deposition can also be carried out by a vacuum technique, for example by cathode sputtering from a Si target (optionally doped) or a silicon suboxide target (in a reactive oxidizing and/or nitriding atmosphere for example). This underlayer preferably has a thickness of at least 5 nm, particularly a thickness of 10 nm to 200 nm, for example between 80 nm and 120 nm.

The anti-reflective coating can also comprise an overlayer if it does not alter the anti-reflective properties.

It is also possible to place an anti-reflective coating likewise on face F1 facing that on face F2.

More broadly, facing the first through-hole, the lamination interlayer has a first through-hole or partial through-hole of the interlayer and facing the second through-hole, the lamination interlayer has a through-hole or partial through-hole of the interlayer

Without departing from the scope of the invention, the lamination interlayer clearly can comprise several different types of laminations made of thermoplastic material, for example, with different hardnesses in order to provide an acoustic function, as disclosed, for example, in publication U.S. Pat. No. 6,132,882, particularly a set of PVB laminations with different hardnesses. Similarly, one of the glass sheets can be thin compared to the thicknesses conventionally used.

The lamination interlayer according to the invention can have a wedge-shape, particularly in view of an HUD (Head Up Display) application. One of the laminations of the interlayer can also be batch-tinted.

The preferred lamination interlayer comprises 60% to 80% and even 70% to 75% of PVB, 25 to 30% of plasticizer and optionally at most 1% of additives.

As a common lamination interlayer, other than PVB (preferably with plasticizers), a flexible polyurethane PU, a thermoplastic without plasticizer such as ethylene-vinyl acetate copolymer (EVA), an ionomer resin can be cited. These plastics have a thickness, for example, of between 0.2 mm and 1.1 mm, particularly 0.3 and 0.7 mm.

The lamination interlayer can comprise another functional plastic film (transparent, clear or tinted), for example, a polyethylene terephthalate PET film supporting a layer that is athermal, electroconductive, etc., for example, a PVB/functional film/PVB between the faces F2 and F3.

The plastic film can have a thickness of between 10 and 100 μm. The plastic film can more broadly be made of polyamide, polyester, polyolefin (PE: polyethylene, PP: polypropylene), polystyrene, polyvinyl chloride (PVC), polyethylene terephthalate (PET), polymethyl methacrylate (PMMA) or polycarbonate (PC). A clear film is preferred, in particular PET.

Use may be made, for example, of a coated clear PET film, for example XIR from the company Eastman, a coextruded film made of PET-PMMA, for example like SRF 3M®, but also numerous other films (for example made of PC, PE, PEN, PMMA, PVC).

The lamination interlayer can comprise a PVB (preferably with plasticizers), optionally comprising PVB/functional film as polymer film with athermal coating/PVB, optionally acoustic PVB, tinted PVB having two through-holes or partial through-holes in line with the first and second through-holes.

The glazing can comprise a first total through-hole which can consist:
of a first interlayer through-hole in the lamination interlayer (single or multi-laminations) of width D1
and of the first through-hole in the second glass sheet of width D2

These holes are of coincident or nearly coincident axis of symmetry and preferably of identical width (before and even after lamination).

And the glazing can comprise a second total through-hole which can consist:
of a second interlayer through-hole in the lamination interlayer (single or multi-laminations) of width D′1
and of the second through-hole in the second glass sheet of width D′2.

These holes are of coincident or nearly coincident axis of symmetry and preferably of identical width (before and even after lamination).

The first interlayer hole can be wider than the first through-hole (at least before lamination) in particular by at most 5 mm or 10 mm. The second interlayer hole can be wider than the second through-hole (at least before lamination) in particular by at most 5 mm or 10 mm.

Obviously, each first or second through-hole of the glass can be an empty space or at least a space that is not filled (in its central part) by any material that is too absorbent in the targeted near infrared which would be in the field of the infrared vision system.

It is possible to provide a first insert (closed, open) like a ring (monolithic or in several separated or connected pieces etc.) particularly with a width of at most 1.5 cm for example made of flexible material, polymer (polycarbonate, polyamide, polyolefin, polypropylene, polytetrafluoroethylene, etc.):
installed on (particularly adhered or by force) the wall of the second glass sheet delimiting (at the top) the first through-hole
and/or when the interlayer is entirely or partially pierced in line with the first through-hole (on the side of face F3) or likewise in contact with the wall of the lamination interlayer and even on face F2.

This first ring insert can extend beyond the first through-hole, particularly on face F4.

This first ring insert can be used:
to place in the first hole all or part of the infrared vision system or an intermediate lens
to place in the first hole all or part of attachment means for the infrared vision 30 system.

If the first hole of the interlayer is made before lamination and the first ring insert is placed before lamination at the interlayer (particularly at most 150° C. and under pressure particularly), this first insert can be used to avoid or reduce the creep of the pierced interlayer.

It is possible to provide in the same manner a second insert (closed, open) like a ring (monolithic or in several separated or connected pieces etc.) particularly with a width of at most 1.5 cm for example made of flexible material, polymer (polycarbonate, polyamide, polyolefin, polypropylene, polytetrafluoroethylene, etc.):
installed on (particularly adhered or by force) the wall of the second glass sheet delimiting (at the top) the second through-hole
and/or when the interlayer is entirely or partially pierced in line with the 15 second through-hole (on the side of face F3) or likewise in contact with the wall of the lamination interlayer and even on face F2.

This second ring insert can extend beyond the second through-hole, particularly on face F4.

In one embodiment, for safety purposes, facing the first through-hole, the lamination interlayer has a first interlayer through-hole and, a first piece (curved, flexible) is present under or inside the first through-hole, transparent at the working wavelength, particularly with a thickness of at most 1 cm or 5 mm or 1 mm, which is adhered onto face F2 bare or coated with a first functional layer transparent at least at one infrared working wavelength in a range from 800 nm to 1800 nm, in particular between 850 nm and 1600 nm.
and preferably facing the second through-hole, the lamination interlayer has a second through-hole and, a second piece (curved, flexible) is present under and/or inside the second through-hole, particularly with a thickness of at most 1 cm or 5 mm or 1 mm, transparent at the working wavelength which is adhered onto face F2 bare or coated with a second functional layer transparent at least at one infrared working wavelength in a range from 800 nm to 1800 nm, in particular between 850 nm and 1600 nm particularly discrete or an extension of the first functional layer.

The first and second functional layers (for example heating coating) can be separated or not for example a functional surface encompasses first and second functional (zones) layers.

The first piece (and the second piece) can be made of polymer material, extra clear glass.

The thickness of adhesive is for example less than the thickness of the first sheet particularly sub-millimetric. The first piece is then simultaneously under and inside the first through-hole, even flush with the hole, or even projecting from the hole.

The first piece (and/or the second piece) can be adhered by any known adhesive.

The first piece can have a width of less than the width of the first through-hole, leaving a space between the first through-hole and the first face which is for example of at most 5 mm or 3 mm and even of at least 0.5 mm. This space is empty or completely or partially filled with a material (particularly transparent at the working wavelength) for example a resin, an adhesive.

Similarly, the second piece can have a width of less than the width of the second through-hole, leaving a space between the first through-hole and the first face which is for example of at most 5 mm or 3 mm and even of at least 0.5 mm. This space is empty or completely or partially filled with a material (particularly transparent at the working wavelength) for example a resin, an adhesive.

The external face of the first piece can be under or inside the first through-hole or projecting toward the side of the passenger compartment. The external face of the second piece can be under or inside the first through-hole or projecting toward the side of the passenger compartment.

The first piece preferably comprises a main external face with an anti-reflective coating at least at one so-called infrared working wavelength in a range from 800 nm to 1800 nm, in particular between 850 nm and 1600 nm, particularly based on (nano)porous silica and preferably the second piece comprises a main external face with an anti-reflective coating at least at one so-called infrared working wavelength in a range from 800 nm to 1800 nm, in particular between 850 nm and 1600 nm.

As already mentioned, the glazing can comprise between face F2 and Fa, an opaque masking layer particularly an enamel (black etc.) on face F2 and/or on face Fa (in particular on Fa an ink particularly black etc.), on the border of the first through-hole between face F2 and Fa, in particular on the peripheral zone and even central and preferably along the longitudinal edge of the glazing, the anti-reflective coating (particularly the layer of porous silica or an optional underlayer of dense silica) being optionally in contact with the opaque masking layer.

The masking layer is for example on face F2 and the anti-reflective coating is on the masking layer or under the masking layer and/or the masking layer is on face Fa and the anti-reflective coating is in contact with the masking layer. The masking layer can then have a gap gap in line with said first through-hole (at least in the central zone) and preferably protrudes by at most 50 mm, 30 mm or 20 mm or 10 mm, 7 mm or 5 mm in said first through-hole and/or leaves the anti-reflective coating with the free surface in the first hole, free surface (not coated with a masking layer) having a length of at least 5 cm, 10 cm, 15 cm and preferably of at most 30 cm.

The masking layer can then have a gap gap in line with said second through-hole (at least in the central zone) and preferably protrudes by at most 50 mm, 30 mm or 20 mm or 10 mm, 7 mm or 5 mm in said second through-hole and/or leaves the anti-reflective coating with the free surface in the second hole, free surface (not coated with a masking layer) having a length of at least 5 cm, 10 cm, 15 cm and preferably of at most 30 cm.

This masking layer masks the infrared vision system and for example its casing.

A masking layer can be a printed layer on the lamination interlayer for example on the PVB.

The anti-reflective coating (particularly the porous silica layer or a possible underlayer of dense silica) in the first and second hole can also be spaced apart from the masking layer (for example which is on face F2 particularly of the enamel) or at least does not cover same.

The opaque masking layer is preferably a continuous layer (flattened with a solid edge or alternatively a gradient edge (set of patterns).

The masking layer can be at 2 mm or 3 mm (less than 5 mm) from the edge face of the glazing (closest).

The masking layer can be a band framing the glazing (windscreen etc.) particularly in black enamel. A gap is thus created in this masking layer. Another masking layer (particularly black enamel etc.) can be on face F3 or F4 particularly facing toward the masking layer (and even of identical nature, for example a particularly black enamel).

The glazing can thus comprise on face F2 a functional layer (athermal) extending over all or part of the glazing, particularly electroconductive, optionally heating, in particular a silver stack, or even a masking layer, particularly an enamel, which is absorbent at an infrared working wavelength in a range from 800 nm to 1800 nm, in particular between 850 nm and 1600 nm and
absent from said first through-hole at least in the central zone and on the border of the first through-hole between face F2 and Fa, particularly by means of a first resist
and absent from said second through-hole at least in the central zone and on the border of the second through-hole between face F2 and Fa, particularly by means of a second resist
and/or a functional coating is on face F2, transparent at the working wavelength, is facing the first through-hole and the second through-hole and even between the first and second through-holes, particularly anti-reflective, being optionally in contact with said functional layer, particularly on or under the functional layer.

The functional layer can then have a first gap in line with said first through-hole (at least in the central zone) and preferably which protrudes by at most 50 mm, 30 mm or 20 mm or 10 mm, 7 mm or 5 mm in said second through-hole.

The functional layer can then have a second gap in line with said second through-hole (at least in the central zone) and preferably which protrudes by at most 50 mm, 30 mm or 20 mm or 10 mm, 7 mm or 5 mm in said second through-hole.

The functional layer (sunlight control and/or heating) can comprise a stack of thin layers comprising at least one metal functional layer such as silver (on F2 or preferably F3). The or each functional layer (silver) is disposed between two dielectric layers.

The functional layers preferably contain at least one metal, for example, silver, gold, copper, nickel and chromium or, or a metal alloy. The functional layers in particular preferably contain at least 90% by weight of metal, in particular at least 99.9% by weight of metal. The functional layers can be made of metal for the metal alloy. The functional layers contain in a particularly preferred manner silver or an alloy containing silver. The thickness of a functional layer (silver, etc.) is preferably from 5 nm to 50 nm, more preferentially from 8 nm to 25 nm. A dielectric layer contains at least one individual layer made of a dielectric material, for example, containing a nitride such as silicon nitride or an oxide such as aluminum oxide. The dielectric layer can however also contain a plurality of individual layers, for example, individual layers of a dielectric material, layers, smoothing layers, which corresponds to blocking layers and/or anti-reflective layers. The thickness of a dielectric layer is, for example, from 10 nm to 200 nm. This layer structure is generally obtained by a series of deposition operations that are carried out by a vacuum process such as field-supported magnetic cathode sputtering.

The electrically conductive layer is a layer (single-layer or multi-layer thus a stack) preferably with a total thickness less than or equal to 2 μm, in a particularly preferred way less than or equal to 1 μm.

In order to limit heating in the passenger compartment or to limit the use of air conditioning, at least one of the glass sheets (preferably the exterior glass) is tinted, and the laminated glazing can also comprise a layer which reflects or absorbs solar radiation, preferably on face F4 or on face F2 or F3, in particular a transparent electrically conductive oxide layer, known as a TCO layer, (on face F4) or even a stack of thin layers comprising at least one TCO layer, or stacks of thin layers comprising at least one silver layer (on F2 or F3), the or each silver layer being arranged between dielectric layers.

The layer (silver) on face F2 and/or F3 and TCO layer on face F4 can be combined.

The TCO (“transparent conductive oxide”) layer is preferably a layer of fluorine-doped tin oxide (SnO₂:F) or a layer of mixed indium tin oxide (ITO).

This layer is if necessary absent from said first through-hole at least in the central zone of said first through-hole and present on the border of the first through-hole between face F2 and Fa, absent from said second through-hole at least in the central zone of said second through-hole and present on the border of the second through-hole between face F2 and Fa

Naturally, the most desirable application is that the glazing be a windscreen for a road vehicle (automobile) or even for a rail vehicle (moderate speed).

For the glass of the first glass sheet and/or of the second glass sheet, preferably a soda-lime-silica type glass is used.

The interior and/or exterior glass may have undergone a chemical or heat treatment of the hardening or annealing type or may have undergone tempering (particularly in order to obtain better mechanical strength) or can be semi-tempered.

The glass of the first glass sheet and/or of the second glass sheet is preferably of the float glass type, that is to say obtainable by a method consisting of pouring molten glass onto a bath of molten tin (called a “float” bath). The terms “atmosphere” and “tin” faces are understood to mean those faces that have been in contact with the atmosphere in the float bath and in contact with the molten tin respectively. The tin face contains a small surface amount of tin that has diffused into the structure of the glass.

Face F2 with an (anti-reflective) coating can be the “tin” face as well as the “atmosphere” face.

Furthermore, to quantify the transmission of glass in the visible region, a factor of light transmission, referred to as light transmission, is often defined, often abbreviated “TL”, calculated between 380 and 780 nm and applied to a glass thickness of 3.2 mm or 4 mm, according to standard ISO 9050:2003, thus taking into account the illuminant D65 as defined by standard ISO/CIE 10526 and the C.I.E. 1931 standard colorimetric observer as defined by standard ISO/CIE 10527.

Naturally, the light transmission TL of the laminated glazing in a zone without a hole (central zone of the windscreen) is preferably of at least 70% or 75%, 80% or 85%, 88%.

The second glass sheet is particularly green, blue, gray. The second glass sheet can be green by Fe₂O₃ or blue with CoO and Se or gray with Se and CoO.

The glasses of the applicant called TSAnx (0.5 to 0.6% iron) TSA2+, TSA3+(0.8 to 0.9% iron), TSA4+(1% iron), TSA5+, for example green, can be particularly mentioned. TSA3+(2.1 mm) for example has a total transmission at 905 mm of about 40% and at 1550 mm of about 50%.

The second glass sheet can have a redox, defined as being the ratio between the content by weight of FeO (ferrous iron) and the total iron oxide content by weight (expressed in the form Fe₂O₃) between 0.22 and 0.35 or 0.30.

Said second glass sheet can have a chemical composition that comprises the following constituents in a content varying within the limits by weight defined hereinafter:

| | |
|---|---|
| SiO₂ | 64-75% |
| Al₂O₃ | 0-5% |
| B₂O₃ | 0-5%, |
| CaO | 2-15% |
| MgO | 0-5% |
| Na₂O | 9-18% |
| K₂O | 0-5% |
| SO₃ | 0.1-0.35% |
| Fe₂O₃ | at least 0.4% and |
| (total iron) | even 0.4 to 1.5%, |
| Optionally redox | 0.22-0.3 |

And particularly less than 0.1% impurities.

The first glass sheet can for example be a soda-lime-silica glass such as Saint-Gobain Glass's Diamant®, or Pilkington's Optiwhite®, or Schott's B270®, or AGC's Sunmax® or of other composition described in document WO04/025334. The Planiclear® glass from the Saint-Gobain Glass company can also be chosen.

The glazing according to the invention, in particular for a private car (windscreen etc.) or truck, can be curved (convex) in one or more directions particularly with a radius of curvature of 10 cm to 40 cmm. It can be flat for buses, trains, tractors.

With ordinary natural raw materials, the total content by weight of iron oxide is of the order of 0.1% (1000 ppm). To reduce the iron oxide content, particularly pure raw materials can be selected.

In the present invention, the Fe₂O₃ content (total iron) of the first glass sheet is preferably less than 0.015%, even less than or equal to 0.012%, particularly 0.010%, in order to increase the near-infrared transmission of the glass. The Fe₂O₃ content is preferably greater than or equal to 0.005%, particularly 0.008% so that the cost of the glass is not a disadvantage.

In order to further increase the infrared transmission of the first glass sheet, the ferrous iron content can be reduced in favor of the ferric iron, thus oxidizing the iron present in the glass. Thus, the desire is for glasses having the lowest possible redox, ideally zero or nearly zero. This number can vary between 0 and 0.9 of zero redoxes corresponding to a totally oxidized glass.

Glasses comprising low quantities of iron oxide, particularly less than 200 ppm, even less than 150 ppm, have a natural tendency to have high redoxes, greater than 0.4, even 0.5. This tendency is probably due to the displacement of the oxidation-reduction equilibrium of the iron based on the content of iron oxide.

The redox of the first glass sheet is preferably greater than or equal to 0.15, and particularly between 0.2 and 0.30, particularly between 0.25 and 0.30. In fact, excessively low redoxes contribute to reducing the working life of the furnaces.

In the glasses according to the invention (first and second sheet), the silica SiO₂ is generally maintained within narrow limits for the following reasons. Above 75%, the viscosity of the glass and its aptitude for devitrification increase greatly, which makes its melting and pouring onto the molten tin bath more difficult. Below 60%, particularly 64%, the hydrolytic resistance of the glass decreases rapidly. The preferred content is between 65 and 75%, particularly between 71 and 73%.

Said first glass sheet can have a chemical composition that comprises the following constituents in a content varying within the limits by weight defined hereinafter:

| | |
|---|---|
| SiO₂ | 60-75% |
| Al₂O₃ | 0-10% |
| B₂O₃ | 0-5%, preferably 0 |
| CaO | 5-15% |
| MgO | 0-10% |
| Na₂O | 5-20% |
| K₂O | 0-10% |
| BaO | 0-5%, preferably 0, |
| SO₃ | 0.1-0.4% |
| Fe₂O₃ (total iron) | 0 to 0.015%, |
| and redox | 0.1-0.3. |

Throughout the text, the percentages are percentages by weight.

The glass sheets are preferably formed by floating on a tin bath. Other types of forming methods can be used, such as drawing methods, down-draw method, lamination method, Fourcault method, etc.

The glass composition of the first glass sheet can comprise, other than the inevitable impurities contained particularly in the raw materials, a small proportion (up to 1%) of other constituents, for example agents aiding in the melting or refining of the glass (Cl, etc.), or even elements resulting from the dissolving of the refractories used in the construction of the furnaces (for example ZrO₂). For the reasons already mentioned, the composition according to the invention preferably does not comprise oxides such as Sb₂O₃, As₂O₃ or CeO₂.

The composition of the first glass sheet preferably does not comprise any infrared absorbing agent (particularly for a wavelength comprised between 800 and 1800 nm). In particular, the composition according to the invention preferably does not contain any of the following agents: oxides of transition elements such as CoO, CuO, Cr₂O₃, NiO, MnO₂, W₂O₅, rare earth oxides such as CeO₂, La₂O₃, Nd₂O₃, Er₂O₃, or coloring agents in elemental state such as Se, Ag, Cu. Among the other agents also preferably excluded are the oxides of the following elements: Sc, Y, Pr, Sm, Eu, Gd, Tb, Dy, Ho, Tm, Yb, Lu. These agents often have a very powerful undesirable coloring effect, appearing at very small quantities, sometimes on the order of a few ppm or less (1 ppm=0.0001%). Their presence thus very greatly reduces the transmission of the glass.

Preferably, the first glass sheet has a chemical composition that comprises the following constituents in an amount varying within the limits by weight as defined hereinafter:

| | |
|---|---|
| SiO₂ | 60-75% |
| Al₂O₃ | 0-10% |
| B₂O₃ | 0-5%, preferably 0 |
| CaO | 5-15% |
| MgO | 0-10% |
| Na₂O | 5-20% |
| K₂O | 0-10% |
| BaO | 0-5%, preferably 0, |
| SO₃ | >0.2-0.4% |
| Fe₂O₃ (total iron) | 0 to 0.015%, |
| And redox | 0.2-0.30. |

The first glass sheet can have a chemical composition that comprises the following constituents in a content varying within the limits by weight as defined hereinafter:

| | |
|---|---|
| SiO₂ | 60-75% |
| Al₂O₃ | 0-10% |
| B₂O₃ | 0-5%, preferably 0 |
| CaO | 5-15% |
| MgO | 0-10% |
| Na₂O | 5-20% |
| K₂O | 0-10% |
| BaO | 0-5%, preferably 0, |
| SO₃ | 0.1-0.4% |
| Fe₂O₃ (total iron) | 0 to 0.02%, |
| And redox | 0.15-0.3. |

In the present invention, the Fe₂O₃ content (total iron) is preferably less than 0.015%, even less than or equal to 0.012%, particularly 0.010%, in order to increase the near infrared transmission of the glass. The Fe₂O₃ content is preferably greater than or equal to 0.005%, particularly 0.008% so that the cost of the glass is not a disadvantage.

The redox is preferably greater than or equal to 0.15, and particularly between 0.2 and 0.30, particularly between 0.25 and 0.30. In fact, excessively low redoxes contribute to reducing the working life of the furnaces.

In the glasses according to the invention, the silica SiO₂ is generally maintained within narrow limits for the following reasons. Above 75%, the viscosity of the glass and its aptitude for devitrification increase greatly, which makes its melting and pouring onto the molten tin bath more difficult. Below 60%, particularly 64%, the hydrolytic resistance of the glass decreases rapidly. The preferred content is between 65 and 75%, particularly between 71 and 73%.

Other preferred compositions according to the invention are reproduced below:

| | |
|---|---|
| SiO₂ | 65-75% |
| Al₂O₃ | 0-3% |
| CaO | 7-12% |
| MgO | 2-5% |
| Na₂O | 10-15% |
| K₂O | 0-5% |
| SO₃ | 0.1-0.3% |
| Fe₂O₃ (total iron) | 0 to less than 0.015%, |
| And redox | 0.1-0.3. |

Other preferred compositions according to the invention are reproduced below:

| | |
|---|---|
| SiO₂ | 65-75% |
| Al₂O₃ | 0-5% |
| CaO | 7-12% |
| MgO | 1-5% |
| Na₂O | 10-15% |
| K₂O | 0-5% |
| SO₃ | 0.2-0.4% |
| Fe₂O₃ (total iron) | 0 to less than 0.015%, |
| And redox | 0.1-0.3. |

The invention also relates to a device, which comprises:
the glazing as previously described
an infrared vision system at an infrared working wavelength in a range from 800 nm to 1800 nm, in particular between 850 nm and 1600 nm, (or multi-spectral, in the visible region, particularly between 500 and 600 nm), disposed in the passenger compartment behind said glazing and comprising an emitter, so as to send radiation passing through the first glass sheet at the second through-hole and a receiver so as to receive radiation after it has passed through the first glass sheet at the first through-hole.

Some advantageous but non-limiting embodiments of the present invention are described hereafter, which of course can be combined as appropriate. The views are not to scale.

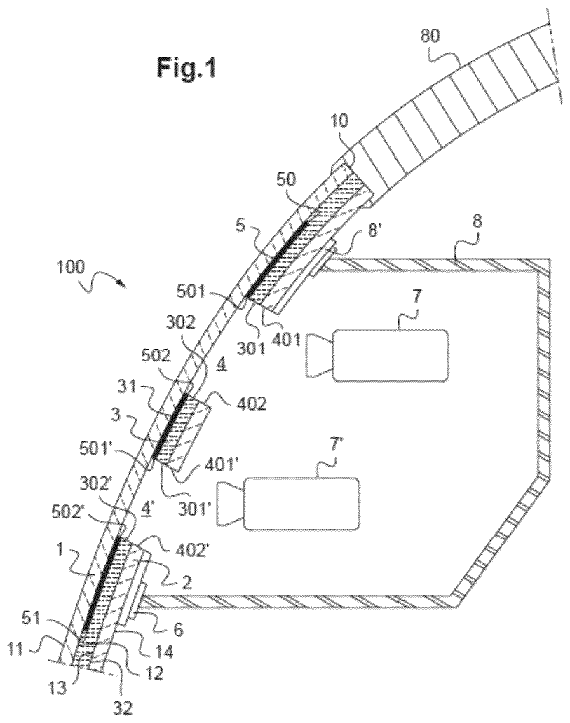

FIG. 1 shows schematically in cross sectional view a windscreen 100 in a first embodiment of the invention with an infrared vision system such as a LIDAR.

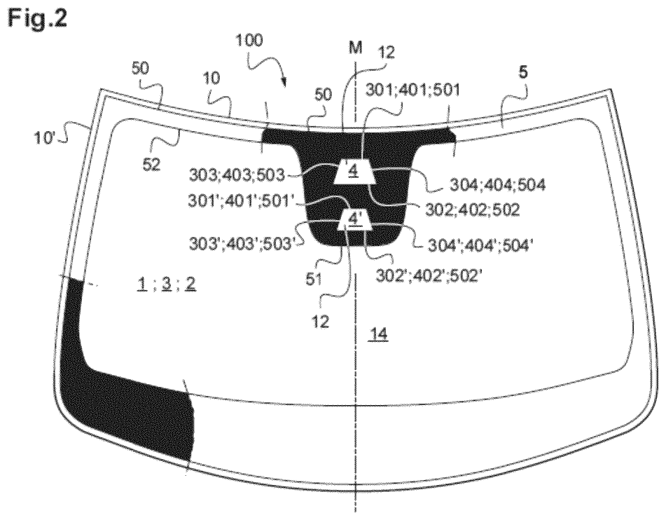

FIG. 2 shows schematically in front view (passenger compartment side) the windscreen 100 of FIG. 1.

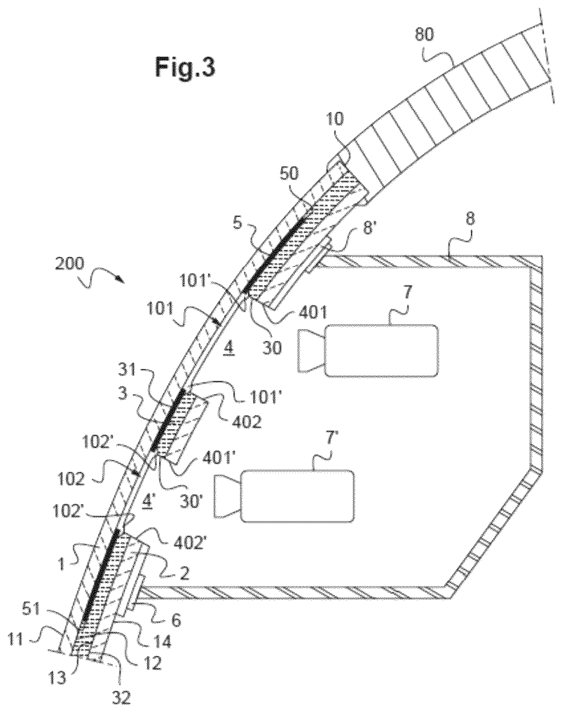

FIG. 3 shows schematically in cross sectional view a windscreen 200 according to the invention with an infrared vision system such as a LIDAR in a second embodiment of the invention.

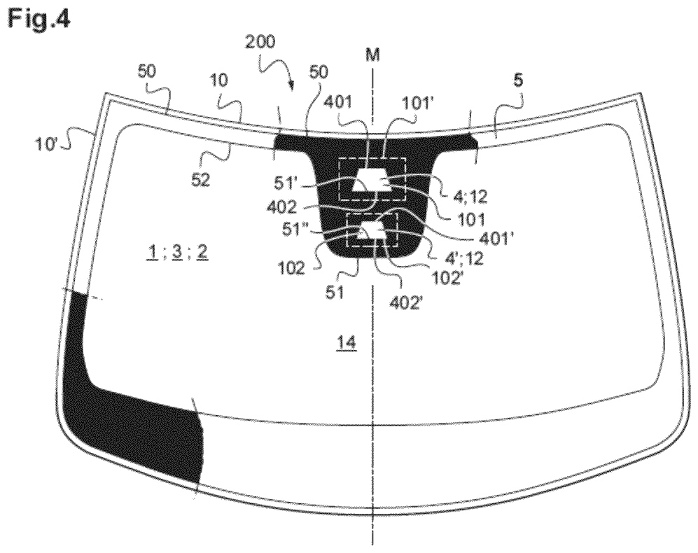

FIG. 4 shows schematically in front view (passenger compartment side) the windscreen 200 of FIG. 3.

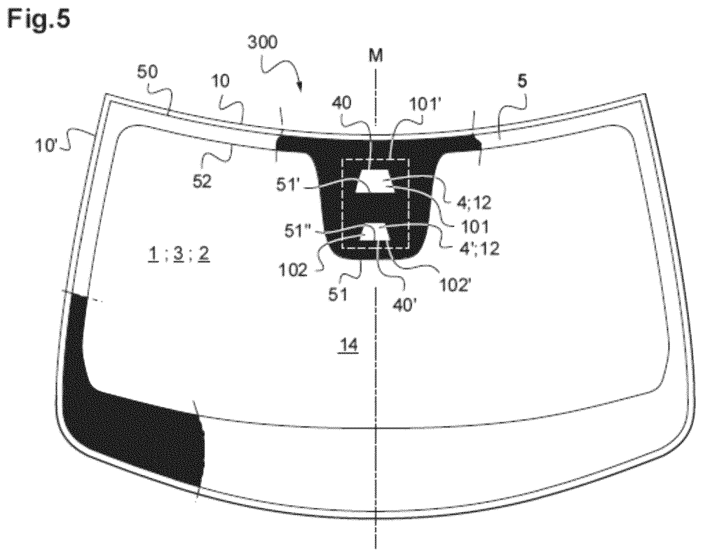

FIG. 5 shows schematically in front view (passenger compartment side) a windscreen 300 in a third embodiment which is a variant of the preceding one.

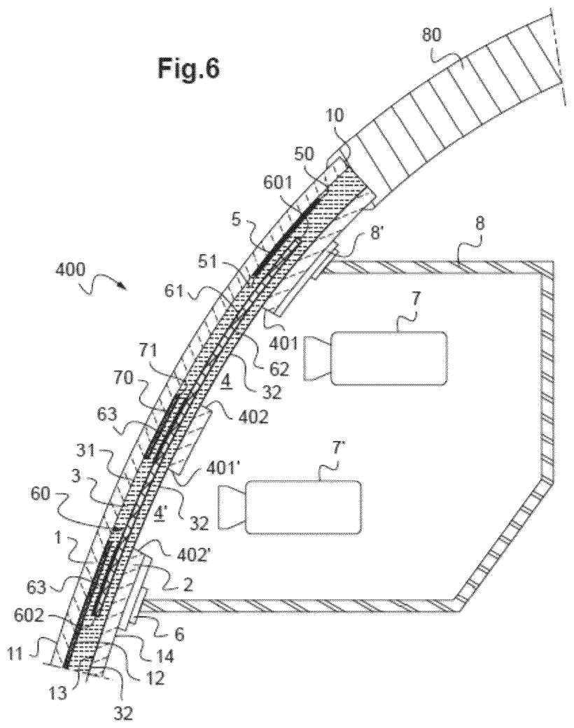

FIG. 6 shows schematically in cross sectional view a windscreen 400 according to the invention with an infrared vision system such as a LIDAR in a fourth embodiment of the invention.

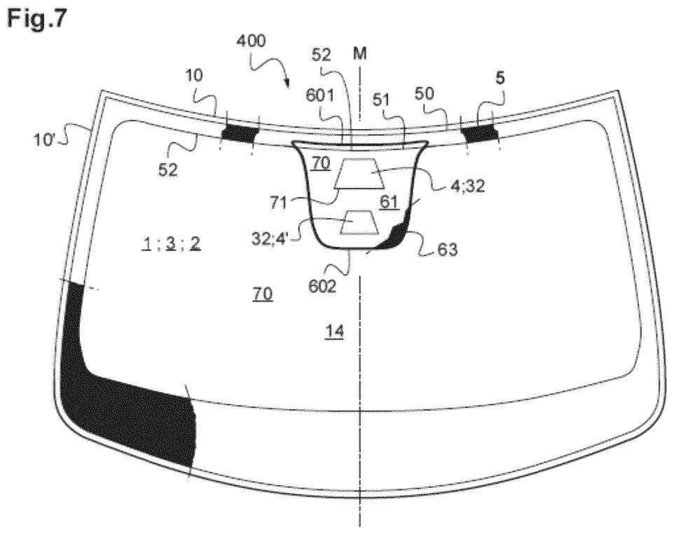

FIG. 7 shows schematically in front view (passenger compartment side) the windscreen 400 of FIG. 6.

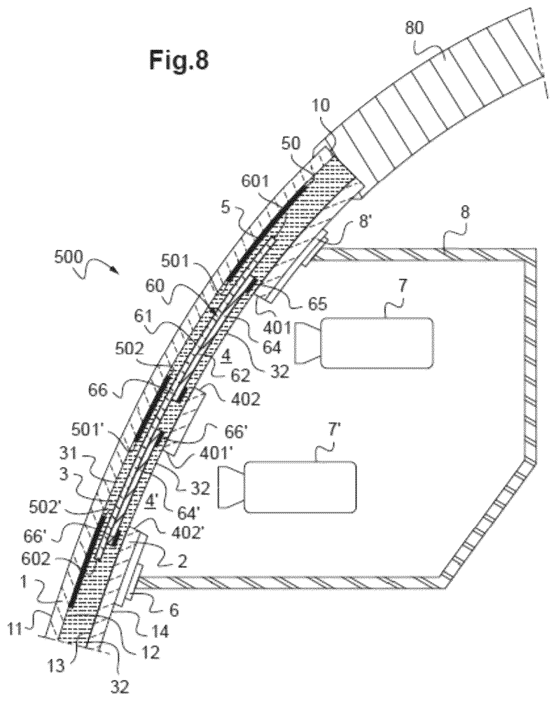

FIG. 8 shows schematically in cross sectional view a windscreen 500 according to the invention, with an infrared vision system such as a LIDAR in a fifth embodiment of the invention.

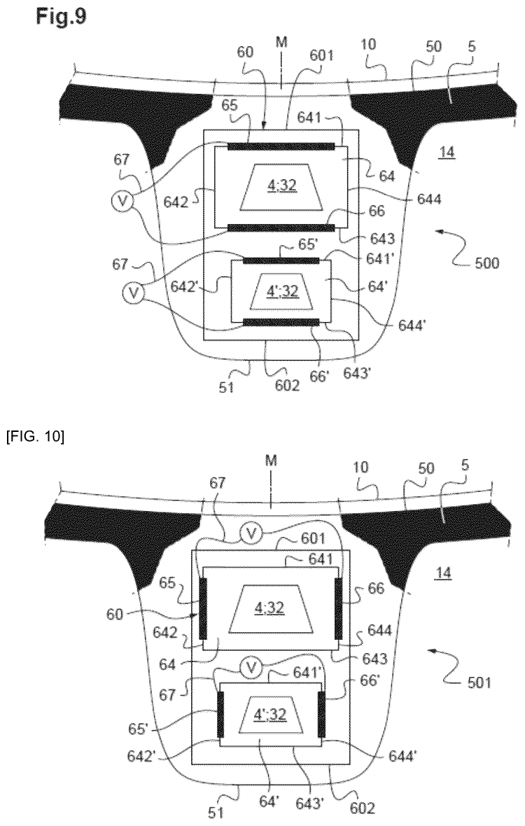

FIG. 9 shows schematically in front view (passenger compartment side) the windscreen of FIG. 8.

FIG. 10 shows schematically in front view (passenger compartment side) the windscreen in a first variant of FIG. 8.

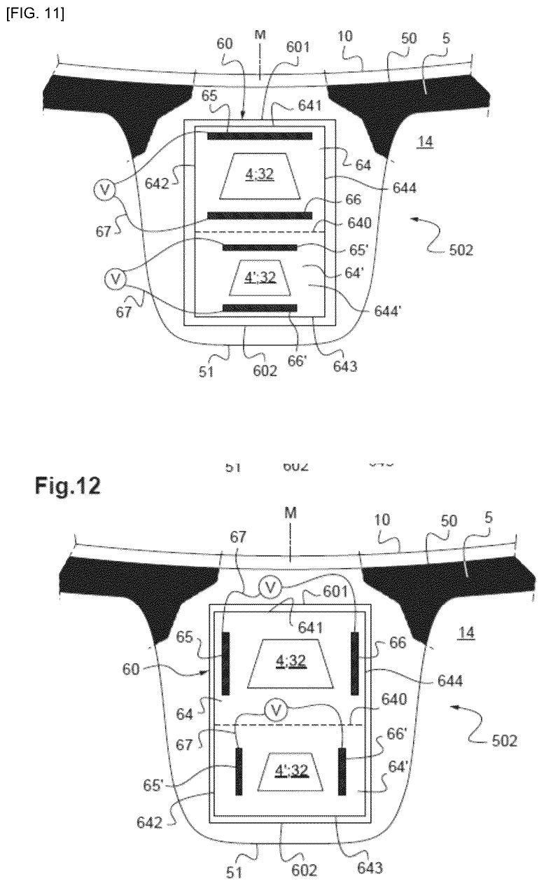

FIG. 11 shows schematically in front view (passenger compartment side) the windscreen in a second variant of FIG. 8.

FIG. 12 shows schematically in front view (passenger compartment side) the windscreen in a third variant of FIG. 8.

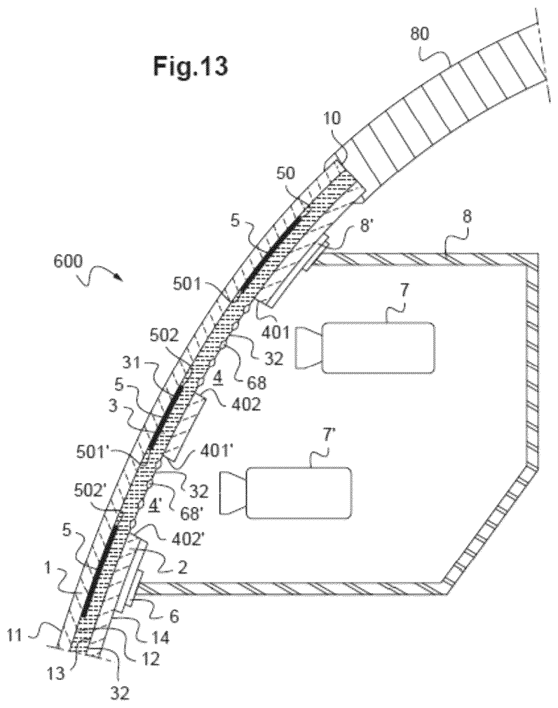

FIG. 13 shows schematically in cross sectional view a windscreen 600 according to the invention, with an infrared vision system such as a LIDAR in a sixth embodiment of the invention.

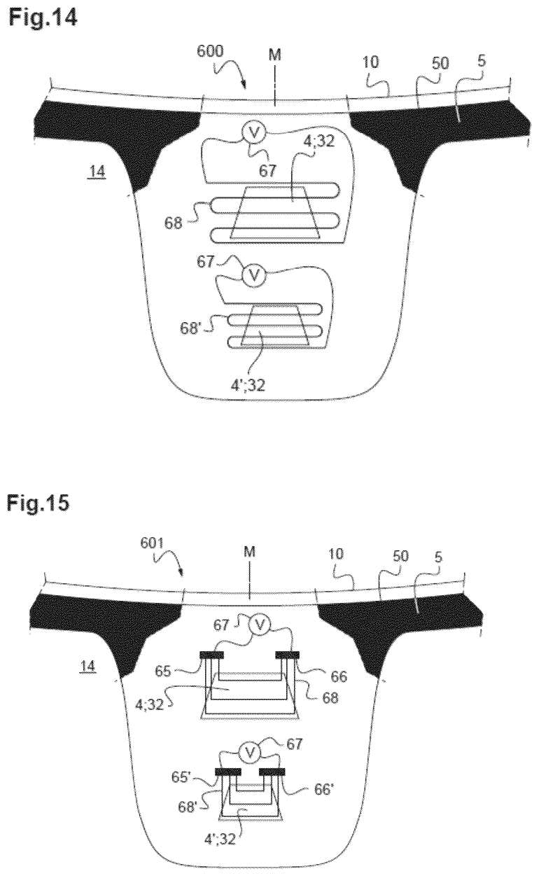

FIG. 14 shows schematically in front view (passenger compartment side) the windscreen 600 of FIG. 13.

FIG. 15 shows schematically in front view (passenger compartment side) the windscreen 601 in a variant of FIG. 13.

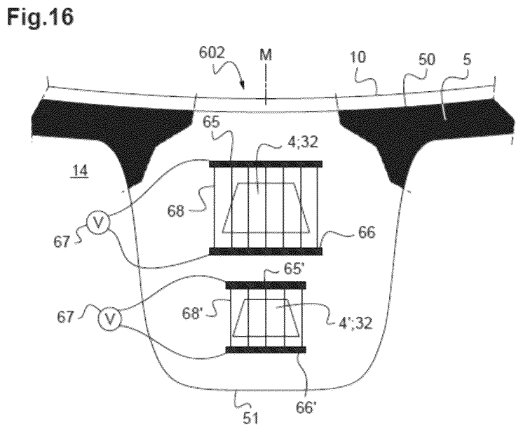

FIG. 16 shows schematically in front view (passenger compartment side) the windscreen 602 in a variant of FIG. 13.

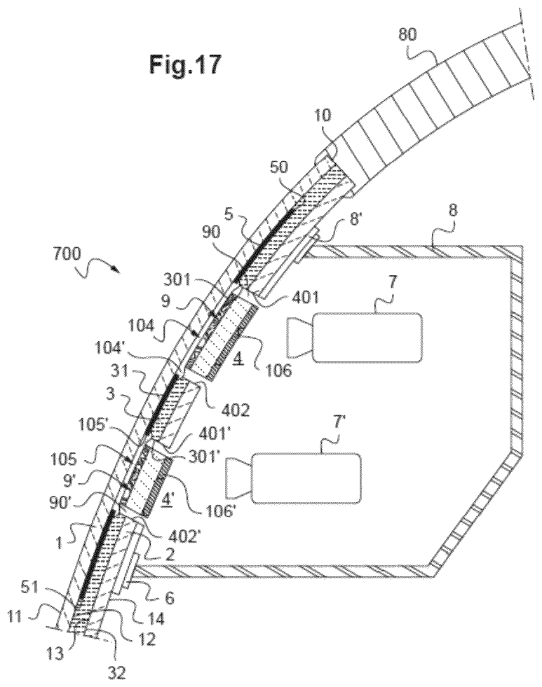

FIG. 17 shows schematically in cross sectional view a windscreen 700 according to the invention, with an infrared vision system such as a LIDAR in a seventh embodiment of the invention.

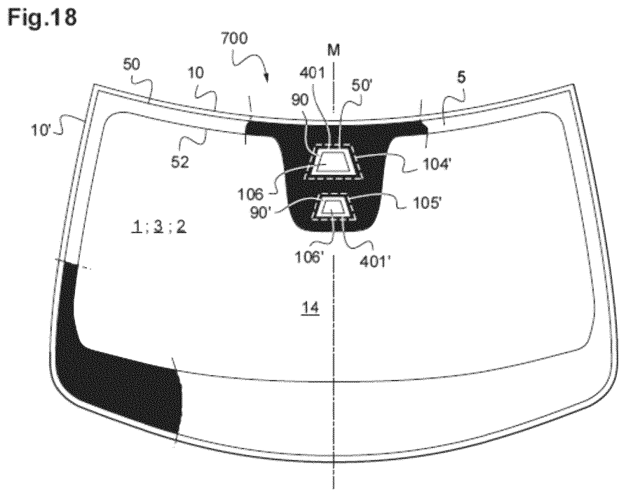

FIG. 18 shows schematically in front view (passenger compartment side) the windscreen 700 of the previous figure.

FIG. 1 shows schematically a windscreen of a vehicle particularly a motor vehicle 100 according to the invention, with an infrared vision system such as a LIDAR at 905 nm or 1550 nm comprising a receiver 7 and an emitter 7′.

This vision system is placed behind the windscreen facing a zone that is preferably located in the central and upper part of the windscreen. In this zone, the infrared vision system is oriented at a certain angle with respect to the surface of the windscreen (face F2 14). In particular, the emitter 7′ and the receiver 7 can be oriented directly toward the image capture zone, in a direction that is nearly parallel to the ground, that is to say slightly inclined toward the road. In other words, the emitter 7′ and the receiver 7 of the LIDAR can be oriented toward the road at a slight angle with a field of vision suitable for fulfilling their functions. The receiver 7 is placed above the emitter 7′ (thus the receiver 7 is further from the ground).

The windscreen 100 is a curved laminated glazing comprising:
an external glass sheet 1, with an exterior face F1 and an interior face F2
and an internal glass sheet 2, for example with a thickness of 1.6 mm or even less, with an exterior face F3 and an interior face F4 on the passenger compartment side
the two glass sheets being bonded to one another by an interlayer made of thermoplastic material 3 (single or multi-laminations), most usually polyvinyl butyral (PVB preferably with plasticizers), preferably clear, of sub-millimetric thickness optionally having a transverse cross section decreasing in the shape of a wedge from top to bottom of the laminated glazing, for example a PVB (RC41 from Solutia or Eastman) with a thickness of about 0.76 mm, or alternatively if necessary an acoustic PVB (three-layer or four-layer), for example with a thickness of about 0.81 mm, for example an interlayer in three PVB laminations, PVB with a main internal face 31 and a main face 32. The windscreen of a road vehicle in particular is curved.

In a conventional and well-known way, the windscreen is obtained by hot lamination of the elements 1, 2 and 3. For example a clear PVB of 0.76 mm is selected.

The first glass sheet 1, particularly silica-based, soda-lime-based, silica-soda-lime-based (preferably), aluminosilicate-based, or borosilicate-based, has a total iron oxide content by weight (expressed in the form Fe₂O₃) of at most 0.05% (500 ppm), preferably of at most 0.03% (300 ppm) and at most 0.015% (150 ppm) and particularly greater than or equal to 0.005%. The first glass sheet can preferably have a redox greater than or equal to 0.15, and particularly between 0.2 and 0.30, particularly between 0.25 and 0.30. Particularly an OPTWHITE glass with a thickness of 1.95 mm is selected.

The second glass sheet 2 particularly silica-based, soda lime-based, preferably soda-lime-silica-based (and like the first glass sheet), even aluminosilicate, or borosilicate-based has a total iron oxide content by weight of at least 0.4% and preferably of at most 1.5%.

The glasses of the applicant called TSAnx (0.5 to 0.6% iron) TSA2+, TSA3+(0.8 to 0.9% iron), TSA4+(1% iron), TSA5+, for example green, can be particularly mentioned. For example a TSA3+ glass with a thickness of 1.6 mm is selected.

According to the invention, in a central peripheral region along the upper longitudinal edge 10, the windscreen 100 comprises:
a first through-hole 4, herein closed, of the second glass sheet 2, first hole 4 thus delimited by a wall of the glass 401 to 404
and even optionally a first closed through-hole of the interlayer in the thickness of the lamination interlayer 3 delimited by an interlayer wall 301 to 304,
under the first through-hole, a second closed through-hole 4′ of the second glass sheet 2, second hole 4′ thus delimited by a wall of the glass 401′ to 404′
and even optionally a second closed interlayer through-hole in the thickness of the lamination interlayer 3 delimited by an interlayer wall 301′ to 304′.

Alternatively one or each interlayer hole can be partial.

A central line M is defined passing through the middle of the upper edge which can be an axis of symmetry of the glazing.

The two vertical through-holes 4, 4′ can be central, and then the line M passes divides each through-hole into two identical parts.

As shown in FIGS. 1 and 2 (cross sectional view according to M), the first through-hole is herein a closed hole (surrounded by the wall of the glass sheet), thus within the glazing particularly—with trapezoidal cross section—comprising:
a first large side 401 or so-called upper longitudinal edge closest to the edge face of the upper longitudinal edge of the glazing 10—parallel to this edge face with a length of at most 20 cm for example 8 cm and spaced apart by at least 5 cm or 6 cm from the edge face (of the large side)
a second large side 402 or so-called lower longitudinal edge (farthest from the edge face of the upper longitudinal edge 10, near the central zone) parallel to the first large side with a length of at most 25 cm or 20 cm and preferably greater than that of the first large side for example 14 cm,
first and second small sides 403, 404, or oblique lateral edges.

The height (between the large sides) is at least 5 cm herein 6 cm.

The second hole 4′ is herein a closed hole (surrounded by the wall of the glass sheet), thus within the glazing particularly—with trapezoidal cross section—
a first large side or so-called upper longitudinal edge 401′ closest to the edge face of the upper longitudinal edge of the glazing 10—parallel to this edge face with a length of at most 20 cm for example 6 cm
a second large side or so-called lower longitudinal edge 402′ (farthest from the edge face of the upper longitudinal edge 10, near the central zone) parallel to the first large side 402 with a length of at most 25 cm or 20 cm and preferably greater than that of the first large side 401′ for example 15 cm
with a height (between the large sides) of at least 5 cm herein 6 cm.

The second hole 4′ is separated by at least 8 cm herein 15 cm from the first hole 4.

The receiver 7 is opposite the first through-hole 4 (upper hole). The emitter 7′ is opposite the second through-hole 4 (lower hole).

The first through-hole 4 (and even the second through-hole 4′ although a closed hole is preferred) can alternatively be a notch and thus a through-hole preferably opening on the side of the roof (on the upper longitudinal edge 10).

The through-holes 4 and 4′ can be in another region of the windscreen 100 or even in another glazing of the vehicle in particular the rear window.

The first interlayer hole can preferably be of identical size or wider than the first hole 4′ of the internal glass.

The first interlayer hole herein has the same trapezoidal shape as the first hole 4 with two large sides 301, 302 and two small sides 303, 304. The first interlayer hole can preferably be identical in size or wider than the first hole 4′ for example the walls 301 to 304 delimiting the interlayer hole being set back by at most 10 mm or 5 mm from the walls of the glass 401 to 404 delimiting the hole 4. Alternatively, it is a rectangle or any other shape encompassing the surface of the first through-hole (trapezoidal or other) 4.

The second interlayer hole can preferably be of identical size or wider than the second hole 4′ of the glass.

The second interlayer hole herein has the same trapezoidal shape as the second hole 4′ with two large sides 301′, 302′ and two small sides 303′, 304′. The second interlayer hole can preferably be identical in size or wider than the second hole 4′ for example the walls 301′ to 304′ delimiting the interlayer hole being set back by at most 10 mm or 5 mm from the walls of the glass 401′ to 404′ delimiting the hole 4′. Alternatively, this is a rectangle or any other shape encompassing the surface of the second through-hole (trapezoidal or other).

The windscreen 100 comprises on face F2 12 an opaque masking layer for example black 5, such as a layer of enamel or a lacquer, forming a peripheral frame of the windscreen (or of the window) particularly along the upper longitudinal edge 10 of the glazing and particularly along the left lateral edge 10′ of the glazing.

The external edge 50 of the masking layer closest to the edge face of the glazing can be spaced apart by 1 or 2 mm to several cm from the edge face 10 (herein upper longitudinal edge).

The masking layer 5 has an internal (longitudinal) edge 51 in the central zone of the windscreen and an internal (longitudinal) edge 52 on either side. The layer 5 herein has a greater width in the central zone than in the peripheral zones, on either side.

This central zone being provided with holes 4, 4′, this masking layer 5 comprises:
in line with the first hole 4, a first gap that is large enough not to affect the performance of the receiver 7, particularly slightly smaller than the first through-hole 4
in line with the second hole 4′, a second gap that is large enough not to affect the performance 7 of the emitter 7′, particularly slightly smaller than the second through-hole 4′.

The first gap herein has the same trapezoidal shape as the first hole 4 with two large sides 501, 502 and two small sides 503, 504. The first gap can be preferably of identical size or smaller than the first hole 4 for example the walls 501 to 504 delimiting the first gap protruding by at most 50 mm or 10 mm or even 5 mm from the walls of the glass 401 to 404 delimiting the first hole 4. Alternatively, this is a rectangle or any other shape particularly inscribed in the surface of the first through-hole (trapezoidal or another).

The second gap herein has the same trapezoidal shape as the first hole 4 with two large sides 501′, 502′ and two small sides 503′, 504′. The second gap can be preferably of identical size or smaller than the second hole 4′ for example the walls 501′ to 504′ delimiting the second gap protruding by at most 50 mm or 10 mm or even 5 mm from the walls of the glass 401′ to 404′ delimiting the second hole 4′. Alternatively, this is a rectangle or any other shape particularly inscribed in the surface of the second through-hole (trapezoidal or another).

The masking layer 5 is capable of masking the casing 8 (plastic, metal, etc.) of the LIDAR 7, 7′. The casing 8 can be adhered to face F4 14 by an adhesive 6 and to the roof 80.

The windscreen 100 can comprise a set of metal wires that are almost invisible, for example with a thickness of 50 μm, which are placed in or on a face of the lamination interlayer 3 (over the entire surface), for example face Fb 32 on the side of F3, in the form of lines that are optionally straight. These almost-invisible metal wires are absent in line with the through-holes 4, 4′.

A first recessed insert (not shown) like a ring with a width of at most 1.5 cm for example made of flexible material, polymer (polycarbonate etc.) can be housed mounted on (particularly adhered or by force)
on the wall of the hole of the lamination interlayer, it can act as a creep barrier and be masked by the masking layer
and/or on the wall 40 of the second glass sheet delimiting (at the top) the first through-hole, to serve as mechanical reinforcement, and/or for attaching the LIDAR, this insert being able to extend beyond the first hole, particularly on face F4.

FIG. 3 shows schematically in cross sectional view a windscreen 200 with an infrared vision system such as a LIDAR in a second embodiment of the invention. FIG. 4 shows schematically in front view (passenger compartment side) the windscreen 200 of FIG. 3.

Only the differences with the first embodiment are explained hereunder.

The first glass sheet comprises, on face F2, an anti-reflective coating 2, at least at one so-called infrared working wavelength from 800 nm to 1800 nm, particularly between 850 nm and 1600 nm with
a first zone 101 with a first free surface (not covered by the lamination interlayer 3 and the second glass sheet 2) opposite the total hole formed by the interlayer through-hole in the thickness of the interlayer and said first through-hole 4, edge zone or contour 101′
a second zone 102 with a second free surface 1 (not covered by the lamination interlayer 3 and the second glass sheet 2) opposite the total hole formed by the interlayer through-hole in the thickness of the interlayer and said first through-hole 4, edge zone or contour 102′.

The anti-reflective coating 101, 102 is local and herein divided into two separated layers for example spaced apart by at least 1 cm, 5 cm. Each zone of the anti-reflective layer 101, 102 has a rectangular shape in this peripheral region (in dotted lines in FIG. 4 since they are not visible) and the edge 20 optionally protruding between face 12 and face Fa 31 for example at most by 10 mm or 5 mm from the walls delimiting the interlayer hole or the through-hole 4. Herein, each zone of the anti-reflective coating is on face F2 and partially covers the optional masking layer 5 on face F2.

The first zone 101 (and optionally the second zone, respectively) of the anti-reflective coating alternatively has another shape for example a shape homothetic to that of the cross section of the first through-hole or interlayer through-hole (and optionally of the second through-hole or interlayer through-hole, respectively) and thus for example a trapezoidal shape.

With an OPTIWHITE glass of 1.95 mm and an anti-reflective coating of 110 nm the following total transmissions are obtained on the side of face F2 at the first and second total hole:
at 90° of 92.5% at 905 nm and 92.0% at 1550 nm
at 60° of 91.7% at 905 nm and 91.5% at 1550 nm.

In an alternative shown in FIG. 5, the windscreen 300 has an anti-reflective coating with a rectangular surface encompassing the first and second anti-reflective zones 101, 102 and is present between the two holes 4 and 4′.

Possible alternatives are as follows (without being exhaustive) optionally cumulative:
the anti-reflective coating does not project beyond the first through-hole (or the second through-hole) and is even spaced apart from the edge of the first through-hole (and of the second through-hole) preferably by at most 1 cm or 5 mm
the anti-reflective coating is spaced apart from the masking layer (for example which is on face F2 particularly of the enamel) or at least does not cover it.
the anti-reflective coating comprises a chemical protection underlayer, particularly a dense silica layer, particularly by sol-gel, with the functional layer of sol-gel (nano)porous silica positioned on top.
face F2 comprises a functional layer (athermal, etc.) under or on the enamel, the anti-reflective coating optionally being in contact with the functional layer particularly on or under the functional layer (athermal, etc.).

FIG. 6 shows schematically in cross sectional view a windscreen 400 according to the invention with an infrared vision system such as a LIDAR in a fourth embodiment of the invention. FIG. 7 shows schematically in front view (passenger compartment side) the windscreen 400 of FIG. 6.

Only the differences with the first embodiment are explained hereunder.

The lamination interlayer 3 for example made of two laminations of PVB does not comprise a hole (or alternatively a partial hole for example in a second interlayer oriented toward face F3, with face Fb 32). Also, in line with the first and second through-holes 4, 4′ the surface 32 can be free.

The opaque masking layer 5 is not widened in the central zone (passing by M). A functional masking element 60 completes the masking (for the outside) in this central zone and is disposed inside the lamination interlayer 3. It has an upper edge 601 under the enamel zone 5 and a lower edge 602 toward the center of the windscreen. The functional masking element 60 comprises a lamination or support particularly made of polymer for example PET of 100 μm, transparent at the working wavelength of the LIDAR with a first main face on the side of face F2 61 and with a second main face on the side of face F3 62.

The first face 61 (alternatively the second main face 62) has a solid layer opaque coating 63 provided with a first trapezoidal gap gap (alternatively rectangular or any other shape) in line with the first through-hole 4 and provided with a second trapezoidal gap gap (alternatively rectangular or any other shape) in line with the second through-hole 4′.

Optionally, face F2 is covered by an athermal electrically conductive layer 70 (sunlight control, heating, etc.) provided with a first trapezoidal gap gap (alternatively rectangular or any other shape) in line with the first through-hole 4 and provided with a second trapezoidal gap gap (alternatively rectangular or any other shape) in line with the second through-hole 4′.

The opaque insert 60 can have a sensor (antenna, etc.), LED screen particularly on face 62 side F3. The opaque insert 60 can comprise other resists for these sensors.

FIG. 8 shows schematically in cross sectional view a windscreen 500 according to the invention, with an infrared vision system such as a LIDAR in a fifth embodiment of the invention. FIG. 9 shows schematically in front view (passenger compartment side) the windscreen 500 of FIG. 8. FIG. 10 shows schematically in front view (passenger compartment side) the windscreen 501 in a first variant of FIG. 8. FIG. 11 shows schematically in front view (passenger compartment side) the windscreen 502 in a second variant of FIG. 8. FIG. 12 shows schematically in front view (passenger compartment side) the windscreen 502 in a third variant of FIG. 8.

Only the differences with the first embodiment are explained hereunder.

The lamination interlayer 3 for example made of two laminations of PVB does not comprise a hole (or alternatively a partial hole for example in a second interlayer oriented toward face F3, with face Fb 32). Also, in line with the first and second through-holes 4, 4′ the surface 32 can be free.

A heating functional element 60 is disposed within the lamination interlayer. It has an upper edge 601 under the enamel zone 5 and a lower edge 602 toward the center of the windscreen. It extends so as to cover the region of the through-holes 4, 4′.

The heating functional element 60 comprises a sheet or support particularly made of polymer for example PET of 100 μm, transparent at the working wavelength of the LIDAR with a first main face on the side of face F2 61 and with a second main face on the side of face F3 62.

The second face 62 (alternatively the first main face 61) has a heating coating 64 facing the first through-hole 4 and facing the second through-hole 4′, forming first and second local heating zones. The heating coating made of material that is transparent at least at one so-called infrared working wavelength in a range from 800 nm to 1800 nm, in particular between 850 nm and 1600 nm.

The coating herein is on first and second separated rectangular heating zones 64, 64′ for example spaced apart by at least 1 cm and optionally of different sizes (smaller second heating zone). The large sides 641, 643 and 641′, 643′ can be parallel to the large sides of the through-hole 4 or 4′. The small sides 642, 644, 642′, 644′ can be parallel to the small sides of the through-hole 4 or 4′. Independent power supplies may be desirable.

The first rectangular heating zone 64 is provided with two electrical leads or first and second horizontal (dedicated) local busbars 65, 66 offset from the first through-hole 4 on either side of the large sides of the first through-hole 4 supplied with power 67 for example at 15 V or 48 V. The second rectangular heating zone 64′ is provided with two electrical leads or third and fourth horizontal local busbars (dedicated) 65′, 66′ offset from the second through-hole 4′ on either side of the large sides of the second through-hole supplied with power 67 for example at 15 V or 48 V.

The length of the busbars preferably equal to or longer than the large sides of the through-holes can be adapted to measure.

In the case of round or oval-shaped through-holes the substantially horizontal busbars can be curved to match the shape of the through-holes.

It is sought to place the busbars as close together as possible in order to increase the power density. Preferably the distance between busbars of each zone is at most 30 mm or 20 mm.

The heating insert 60 can have a sensor (antenna and) electroluminescent screen particularly on face 62 side F3.

The heating insert 60 can also serve as masking insert as previously disclosed. Its extent, the extent of the enamel and the masking layer can be preferably adapted on face 61 herein opposite the heating layer or alternatively even on all or part of the heating layer and the busbars (preferably on face 61).

In FIG. 10, the first, second, third fourth busbars are lateral 65, 66 and 65′, 66′ herein vertical but oblique (not parallel) with respect to the small sides of the through-holes 4, 4′.

Vertical or oblique lateral busbars (parallel with respect to the small sides of the through-holes 4, 4′) may be preferred since horizontal busbars can result in local overthicknesses that lead to distortions.

The first and third busbars can be aligned and the second and fourth busbars can be aligned.

In the case of round or oval-shaped through-holes the lateral busbars can be curved to match the shape of the holes.

In FIG. 11, a variant of FIG. 9, the heating layer 64 is rectangular and encompasses a surface facing the first and second through-holes 4, 4′ in order to form the first and second local heating zones separated by a discontinuity 640, for example of sub-centimetric width, of the heating layer 64.

In FIG. 12, a variant of FIG. 10, the heating layer 64 is rectangular and encompasses a surface facing the first and second through-holes in order to form the first and second local heating zones separated by a discontinuity 640, for example of sub-centimetric width, of the heating layer 64.

In variants not shown of FIG. 9 it is also possible to provide:
to do away with the two busbars 66, 65′ between the two holes and then there are first and second common busbars 65, 66′ at the first and second local heating zones with a common supply of power 67
or at least to do away with one of the second and third busbars 66, 65′ between the two holes and then there are first and second common busbars 65, 66′ at the first and second local heating zones, and the supply of power 67 is adapted.

In a variant not shown, the busbars of the first and second local heating zones, are grouped together in a zone peripheral to the first through-hole particularly which is an upper zone located between the upper longitudinal edge and the first through-hole and/or which is a lateral zone adjacent to a lateral edge of the first through-hole (between the lateral edge of the glazing and the hole).

FIG. 13 shows schematically in cross sectional view a windscreen 600 according to the invention, with an infrared vision system such as a LIDAR in a sixth embodiment of the invention. FIG. 14 shows schematically in front view (passenger compartment side) the windscreen 600 of FIG. 13. FIG. 15 shows schematically in front view (passenger compartment side) the windscreen 601 in a variant of FIG. 13. FIG. 16 shows schematically in front view (passenger compartment side) the windscreen 602 in a variant of FIG. 13.

Only the differences with the first embodiment are explained hereunder.

The lamination interlayer 3 for example made of two laminations of PVB does not comprise a hole (or alternatively a partial hole for example in a second interlayer oriented toward face F3, with face Fb 32). Also, in line with the first and second through-holes 4, 4′ the surface 32 can be free.

Face Fb 32 comprises:
a first heating metal wire 68, anchored to the lamination interlayer, facing the first through-hole 4, first coiling wire (cf. FIG. 14),
a second metal wire particularly heating 68′, herein discrete from said first metal wire, anchored to the lamination interlayer facing the second through-hole 4′, second coiling wire.

Each power supply 67 is independent.

The wires 68, 68′ can also be on the side of face Fa or inside the lamination interlayer. In one alternative embodiment only the first wire is used, the first wire is facing the first through-hole (by coiling), particularly between the first and second through-holes and facing the second through-hole (by coiling). The supply of power can be adapted as a consequence. It is possible to use a flat connector in the upper zone for example between the first hole and the upper longitudinal edge.

In FIG. 15, the first local heating zone comprises a plurality of heating wires 67, connected to the supply of power by two adjacent horizontal busbars 65, 66 in the upper zone above the first through-hole or by a flat connector. The second local heating zone comprises a plurality of heating wires 67′ connected to the supply of power by two adjacent horizontal busbars 65′, 66′ in the zone above the second through-hole 4′ or by a flat connector.

In FIG. 16 the first local heating zone comprises a plurality of first heating wires 67, connected to the supply of power by first and second horizontal busbars 65, 66 on either side of the first through-hole 4. The second local heating zone comprises a plurality of second heating wires 67′ connected to the supply of power by third and fourth adjacent horizontal busbars 65′, 66′ on either side of the second through-hole 4′.

In variants not shown of FIG. 9 it is also possible to provide:
to extend the first wires to be in front of the second through-hole and thus to do away with the two busbars 66, 65′ between the two holes and then there are first and second common busbars 65, 66′ at the first and second local heating zones with a common supply of power 67
or to extend the first wires to be in front of the second through-hole at least to do away with one of the second and third busbars 66, 65′ between the two holes, and then there are first and second and third common busbars 65, 66′ at the first and second local heating zones, and the supply of power 67 is adapted.

In one variant, the busbars or the one or more flat connectors are grouped together in a zone peripheral to the first through-hole particularly an upper zone that is located between the upper longitudinal edge and the first through-hole and/or lateral zone adjacent to a lateral edge of the first through-hole.

FIG. 17 shows schematically in cross sectional view a windscreen 700 according to the invention, with an infrared vision system such as a LIDAR in a seventh embodiment of the invention. FIG. 18 shows schematically in front view (passenger compartment side) the windscreen 700 of the previous figure.

Only the differences with the first embodiment are explained hereunder.

For purposes of mechanical protection, a first piece 9, curved, transparent at least at one working wavelength of the LIDAR, is adhered to face F2 12 coated with an optional first functional layer (heating, etc.) 104 under and inside the first through-hole 4. The first piece is for example polymer or extra clear glass.

The external face of the first piece 9 can be under or inside the first through-hole 4 or like herein projecting toward the side of the passenger compartment. It comprises an anti-reflective coating 106 particularly based on (nano)porous silica for example like the one already disclosed for the second embodiment.

The first piece 9 is spaced apart (space 90 of 2 mm) from the walls 401, 301 delimiting the first through-hole 4 and the interlayer hole. On the border 104′ (protruding from the piece 9′) the layer 104 thus has a free surface.

For the purposes of mechanical protection, a second piece 9′, curved, transparent at least at one working wavelength of the LIDAR, is adhered to face F2 12 coated with an optional functional layer (heating etc.) 105 under and inside the second through-hole 4′. The second piece is for example polymer or extra clear glass.

The external face of the second piece 9′ can be under or inside the second through-hole 4′ or like herein projecting toward the side of the passenger compartment. It comprises an anti-reflective coating 106′ particularly based on (nano)porous silica for example like the one already disclosed for the second embodiment.

The second piece 9′ is spaced apart (space 90′ of 2 mm) from the walls 401′, 301′ delimiting the second through-hole 4′ and the interlayer hole. On the border 105′ (protruding from the piece 9′) the layer 105 thus has a free surface.

1. A vehicle glazing, comprising:
a first glass sheet intended to be the exterior glazing, with a first external main face and a second internal main face oriented toward a passenger compartment;
a lamination interlayer made of polymer material with a first main face oriented toward the second internal main face and a second main face opposite the first main face;
a second glass sheet intended to be the interior glazing with a third main face oriented toward the second internal main face and a fourth internal main face oriented toward the passenger compartment,
the first glass sheet having a total iron oxide content by weight of at most 0.05%,
a first through-hole, in a thickness of the second glass sheet, the first through-hole being centimetric, and
a second through-hole, in the thickness of the second glass sheet, the second through-hole being centimetric, the second through-hole being separated from the first through-hole, under the first through-hole, separated by an interhole distance of at least 8 cm.

2. The vehicle glazing according to claim 1, wherein the second sheet has an upper longitudinal edge face, the first through-hole opens onto said upper longitudinal edge face or is closed, the first through-hole is between the second through-hole and the upper longitudinal edge face.

3. The vehicle glazing according to claim 1, wherein the first through-hole is larger than the second through-hole.

4. The vehicle glazing according to claim 1, wherein the first through-hole has a surface cross section with a largest dimension of at most 20 cm.

5. The vehicle glazing according to claim 1, further comprising at least one metal wire bonded to the lamination interlayer, and optionally absent in front of said first through-hole.

6. The vehicle glazing according to claim 1, further comprising:
a first local heating zone in front of said first through-hole, and
a second local heating zone in front of said second through-hole.

7. The vehicle glazing according to claim 6, further comprising at least two electrical leads which are local busbars.

8. The vehicle glazing according to claim 6, wherein the local busbars or one or more flat connectors of the first and second local heating zones are grouped together in a zone peripheral to the first through-hole.

9. The vehicle glazing according to claim 6, further comprising a heating layer that encompasses a surface facing the first and second through-holes in order to form the first and second local heating zones.

10. The vehicle glazing according to claim 7, further comprising a heating layer and the local busbars are separated by at most 30 cm.

11. The vehicle glazing according to claim 1, further comprising a functional element bonded to the lamination interlayer, wherein the functional element comprising a sheet of sub-millimetric thickness, said functional element comprising:
a first zone facing the first through-hole,
a second zone facing the second through-hole,
said functional element being transparent to an infrared working wavelength in a range from 800 nm to 1800 nm,
and said functional element being present between the first and second through-holes, thus taking up a surface encompassing the first and second through-holes.

12. The vehicle glazing according to claim 11, wherein the functional element comprises on the first main face oriented toward the first external main face or the second internal main face:
the heating electroconductive coating facing the first through-hole and facing the second through-hole, forming first and second local heating zones,
and/or the functional element comprises on the first main face or the second main face an opaque masking element at least partially offset from the first through-hole and at least partially offset facing the second through-hole.

13. The vehicle glazing according to claim 1, wherein the first glass sheet comprises on the second internal main face, a functional coating or a functional film adhered to the second internal main face with sub-millimetric thickness, said functional element comprising:
a first zone facing the first through-hole
a second zone facing the second through-hole,
the functional coating extending under the lamination interlayer between first and second functional surfaces, extending over the second internal main face, under an optional functional layer, or is on an optional functional layer that is on the second internal main face,
the functional coating or film being transparent at least at one infrared working wavelength in a range from 800 nm to 1800 nm.

14. The vehicle glazing according to claim 1, further comprising an anti-reflective coating that is anti-reflective at least at one infrared working wavelength in a range from 800 nm to 1800 nm said anti-reflective coating comprising:
a first free anti-reflective surface in a zone of the first through-hole
a second free anti-reflective surface in a zone of the second through-hole.

15. The vehicle glazing according to claim 14, wherein the anti-reflective coating is on the second internal main face, wherein the lamination interlayer has a first interlayer through-hole facing the first through-hole, and a second interlayer through-hole facing the second through-hole, and wherein optionally the anti-reflective coating extends under the lamination interlayer on the second internal main face, under an optional functional layer, or is on an optional functional layer that is on the second internal main face.

16. The vehicle glazing according to claim 1, wherein facing the first through-hole, the lamination interlayer has a first interlayer through-hole and a first piece is present in the first through-hole, which is transparent at least at one infrared working wavelength in a range from 800 nm to 1800 nm, which is adhered to the bare or coated the second internal main face of a first functional layer.

17. The vehicle glazing according to claim 16, wherein the first piece comprises a main external face with an anti-reflective coating at said infrared working wavelength in a range from 800 nm to 1800 nm.

18. The vehicle glazing according to claim 1, further comprising, on the second internal main face, a functional layer extending over all or part of the vehicle glazing that is absorbent at an infrared working wavelength in a range from 800 nm to 1800 nm and is:
absent from said first through-hole at least in a central zone of said first through-hole and present on a border of the first through-hole between the second internal main face and the first main face, absent from said second through-hole at least in a central zone of said second through-hole and present on a border of the second through-hole between the second internal main face and the first main face,
and/or a functional coating is on the second internal main face, transparent at the working wavelength, is facing the first through-hole and the second through-hole.

19. A device comprising:
said vehicle glazing according to claim 1, and
an infrared vision system adapted to operate at an infrared working wavelength in a range from 800 nm to 1800 nm disposed in the passenger compartment behind said vehicle glazing and comprising an emitter, so as to send radiation passing through the first glass sheet at the second through-hole and a receiver so as to receive radiation after the radiation has passed through the first glass sheet at the first through-hole.

20. The vehicle glazing according to claim 1, wherein the second glass sheet has a total iron oxide content by weight of at least 0.4%.
